(19) United States
(12) Patent Application Publication
(10) Pub. No.: US 2004/0192263 A1
(43) Pub. Date: Sep. 30, 2004

(54) E-mail system and e-mail transmitting method

(75) Inventors: Mayumi Tomikawa, Kawasaki (JP); Masanobu Yuhara, Kawasaki (JP); Mitsuhiro Tamura, Kawasaki (JP); Takashi Imai, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/822,688

(22) Filed: Apr. 13, 2004

Related U.S. Application Data
(63) Continuation of application No. PCT/JP01/09578, filed on Nov. 1, 2001.

(51) Int. Cl. H04M 11/10

(52) U.S. Cl. 455/413; 455/412.2

(57) ABSTRACT

The e-mail system includes: a text information notifying unit (21) for notifying a second information terminal (40) of text information of an e-mail message; a sound information storing unit for storing sound information related to the e-mail message; and a managing unit for managing association between the e-mail message and its related sound data. With this feature, it is possible for a user to reply to an original e-mail message by voice, thereby freeing a user from troublesome inputting text reply. Further, upon receipt of such a voice reply, the sender of the original mail can manage the reply in association with the original mail. Furthermore, upon receipt of an e-mail massage having information about sound information added thereto, it is possible to smoothly obtain the sound information.

### FIELD OF THE INVENTION

The present invention relates to an e-mail system, an e-mail transmission method, an information processing apparatus, an e-mail managing program, and a computer-readable recording medium storing the e-mail managing program thereon, suitable for use in an e-mail system, such as that for mobile phones, which system transmits/receives sound information and e-mail messages (text information) in different methods. The invention is particularly effective in processing sound information associated with an e-mail message.

### DESCRIPTION OF THE RELATED ART

As mobile phones have become increasingly popular, they have been equipped with a variety of functions. For instance, e-mail has been exchanged (transmitted/received) on mobile phones, thus facilitating e-mail communications. It thus becomes possible to deliver information without fail to sales staff, for example, who often work outside and are sometimes difficult to contact using just the telephone communication function of a mobile phone.

More specifically, if there is any information to be notified to a sales staff member who carries a mobile phone, an e-mail message is prepared and sent to his mail address. Upon receipt of such e-mail at his convenience, the staff member can input his reply through dial buttons of his mobile phone and then return the reply mail to the sender of the original mail, so that information can be communicated with high reliability, thereby increasing convenience.

In the meantime, a unified message system has been well-known as a method for communicating messages by using varying types of information equipment such as personal computers, telephones, and facsimiles. The unified message is a type of CTI (Computer Technology Integration) application which makes various types of communication service tools, such as telephones, facsimiles, e-mail, and so on, operate in cooperation with one another, so as to provide users with messages addressed to them in their most convenient forms. More concretely, text information transmitted by e-mail can be converted into voice sound that will be replayed through a telephone, or an e-mail message can be converted into a facsimile message, or a facsimile message can also be converted into an e-mail message.

Some of the products on the market related to the unified message enable a user to use previously prepared repetitive phrases, thereby freeing him from troublesome inputting of character letters through the tiny dial buttons of a mobile phone, and others have a function for inputting a reply to e-mail by voice.

### PROBLEMS TO BE SOLVED BY THE INVENTION

The above-described e-mail system utilizing conventional mobile phones has the following problems. Preparing reply mail on a mobile phone is inconvenient because the keyboard (dial buttons) equipped to a mobile phone is so small that inputting long sentences therethrough is significantly troublesome.

Here, instead of inputting a text message, which forms the message body of a reply mail message, a user can make a phone call to the sender of the original e-mail message so as to reply by voice.

However, even in a case where a user wants to use his mobile phone to call the sender of an e-mail message, it is still troublesome for him to check a phone number to call and to manually input the telephone number.

Further, even if such checking and inputting of the phone number are automated, it still cannot be told whether or not it is convenient for a person (the sender of the original e-mail message) to receive a phone call at that moment. Furthermore, if the person can receive a phone call, it is still difficult for the person to manage the thus-received voice reply and the original message he sent by e-mail in association with each other.

In the meantime, in a case where a user chooses an appropriate one of the repetitive phrases having been previously prepared in the unified message system, it is inconvenient that messages to be transmitted are limited to the repetitive phrases. Further, generally speaking, if a voice reply is made to a received e-mail message, the reply voice sound is transmitted by using a voice mail system prepared separately from the e-mail system. As a result, it is difficult for the receiver of the reply mail (sender of the original e-mail) to associate the e-mail message (text data) he sent out with its reply (sound data), so that the user's convenience is affected.

Further, since conventional mobile phone systems employ a line switching system, in which a line is occupied till a current communication is completed, it is impossible to perform both data communication and audio communication (telephone calls) simultaneously.

Concretely speaking, in a case of mobile banking, or in a case where data communication is in process, audio communication (telephone calls) is unavailable. On the other hand, while audio communication is being performed, data communication is unavailable. Accordingly, conventional mobile phone systems have a problem that it is impossible to smoothly replay sound data attached to a received e-mail message.

With the foregoing problems in view, one object of the present invention is to provide an e-mail system and an e-mail transmission method, which devises sound information processing so as to make it possible for a user to reply by voice to a received e-mail message, thereby freeing a user from troublesome inputting of text messages. Additionally, it becomes possible for the sender of an e-mail message to manage the e-mail and its voice reply in association with each other. Moreover, it also becomes possible to smoothly obtain sound information from an e-mail message that has information about any sound information added thereto. Another object of the present invention is to provide an information processing apparatus, an e-mail managing program, and a computer-readable recording medium storing the e-mail managing program thereon, which are suitable for use in the e-mail system of the present invention and for use in realizing the present e-mail transmission method.

### DISCLOSURE OF THE INVENTION

In order to accomplish the above objects, according to the present invention, there is provided an electronic mail (e-mail) system that has: a first information terminal for transmitting and receiving sound information and text information; a second information terminal for transmitting and receiving sound information and text information in different ways; and a managing apparatus, communicably interconnected between the first information terminal and the second information terminal, for managing an e-mail message that includes at least text information to be transmitted and received between the first information terminal and the second information terminal. The managing apparatus comprises: a text information notifying unit for notifying the second information terminal of the text information included in the e-mail message; a sound information storing unit adapted to store sound information related to thee-mail message; and a managing unit for managing association between the e-mail message and the sound information related to the e-mail message.

As a preferred feature, the managing apparatus further comprises: a telephone number selecting unit for selecting a telephone number for use in handling the sound information related to the e-mail message transmitted from the first information terminal to the second information terminal; a telephone number notifying unit for notifying the second information terminal of the telephone number selected by the telephone number selecting unit; and a managing unit for managing association among the e-mail message, the telephone number, and the sound information related to the e-mail message.

As another preferred feature, the e-mail system further comprises: a caller number obtaining unit for obtaining a telephone number of the second information terminal from which a telephone call is made to the telephone number selected by the telephone number selecting unit; a telephone number detecting unit for detecting whether or not a combination of the telephone number that is selected by the telephone number selecting unit and the telephone number that is obtained by the caller number obtaining unit matches a pre-determined combination; and a selecting unit for selecting, if the detection result by the telephone number detecting unit is positive, the e-mail message as the one to which a reply message is to be made.

As still another preferred feature, the second information terminal includes a reply sound input unit for inputting sound information, as a reply to thee-mail message, through an audio communication line specified by the telephone number. In addition, the sound information storing unit of the managing apparatus stores such sound information input from the reply sound input unit as sound information related to the e-mail message, and the managing apparatus further comprises a reply information notifying unit for notifying the first information terminal of reply information that a reply in sound information form has been obtained from the second information terminal, based on the association managed by the managing unit.

Here, the reply information can be a reply e-mail message, and the reply e-mail message can have the sound information attached thereto, which has been received from the second information terminal and then stored in the sound information storing unit. In addition, the reply e-mail message can have a pointer for use in accessing a section of the sound information storing unit, in which section the sound information is stored.

Alternatively, the reply information can be web data placed on the Internet.

As a further preferred feature, the text information notifying unit of the managing apparatus prepares a notification e-mail message that contains the text information to be notified to the second information terminal; the telephone number selecting unit of the managing apparatus selects a sound input telephone number for use in inputting sound from the second information terminal; and the telephone number notifying unit of the managing apparatus adds information about the sound input telephone number, which is selected by the telephone number selecting unit, to the notification e-mail message, which is prepared by the text information notifying unit.

As a still further preferred feature, the text information notifying unit of the managing apparatus prepares notification web data to which the second information terminal is accessible, which notification web data includes at least the text information received from the first information terminal; the telephone number selecting unit of the managing apparatus selects a sound input telephone number for use in inputting sound from the second information terminal; and the telephone number notifying unit of the managing apparatus adds information about the sound input telephone number, which is selected by the telephone number selecting unit, to the notification web data, which is prepared by the text information notifying unit.

As another preferred feature, the e-mail system further comprises an access detecting unit for detecting whether or not access has been made by the second information terminal to the notification web data. If the detection result obtained by the access detecting unit is positive, the telephone number selecting unit selects a sound input telephone number.

Here, the information about the sound input telephone number is the sound input telephone number itself or an address of a web page indicating the sound input telephone number thereon or a pointer for use in accessing the web page.

As still another preferred feature, the text information notifying unit of the managing apparatus prepares notification web data to which the second information terminal is accessible. The notification web data includes at least the text information received from the first information terminal. In addition, the managing apparatus includes: an access detecting unit for detecting whether or not access has been made by the second information terminal to the notification web data; and a calling unit for calling the second information terminal, if the detection result by the access detecting unit is positive.

As a further preferred feature, the second information terminal includes a reply sound input unit for inputting sound information, as a reply to the e-mail message, through an audio communication line specified by the telephone number. In addition, the sound information storing unit of the managing apparatus stores such sound information input from the reply sound input unit as sound information related to the e-mail message, and the managing apparatus further comprises a reply information notifying unit for notifying the first information terminal of reply information that a reply in sound information form has been obtained from the second information terminal, based on the association managed by the managing unit.

Here, the reply information can be a reply e-mail message. In addition, the reply e-mail message can have the sound information attached thereto, which has been received from the second information terminal and then stored in the sound information storing unit. The reply e-mail message can have a pointer for use in accessing a section of the sound information storing unit in which section the sound information is stored.

Alternatively, the reply information can be web data placed on the Internet.

As a still further preferred feature, if the e-mail message, transmitted from the first information terminal to the second information terminal, has information added thereto about the sound information, the managing apparatus further comprises: a sound information obtaining unit for obtaining the sound information based on the information, added to the e-mail message, about the sound information, which sound information obtaining unit then stores the thus obtained sound information, as the sound information related to the e-mail message, to the sound information storing unit; a sound information reproducing unit for reproducing the sound information stored in the sound information storing unit; and a sound replay unit for replaying the sound information, reproduced by the sound information reproducing unit, through the telephone number.

As another preferred feature, the e-mail system further comprises: a caller number obtaining unit for obtaining a telephone number of the second information terminal from which a telephone call is made to the telephone number selected by the telephone number selecting unit; a telephone number detecting unit for detecting whether or not a combination of the telephone number that is selected by the telephone number selecting unit and the telephone number that is obtained by the caller number obtaining unit matches a pre-determined combination; and a selecting unit for selecting, if the detection result by the telephone number detecting unit is positive, the sound information as that which is to be reproduced by the sound information reproducing unit.

As a further preferred feature, the managing apparatus prepares, based on the association managed by the managing unit, reproduction information, as a reproduction information notification e-mail message, that an e-mail message which is addressed to the second information terminal, and to which information about sound information is added, has been received from the first information terminal.

Here, the reproduction information notification e-mail message can include the telephone number selected by the telephone number selecting unit or a pointer for use in accessing information indicating the telephone number selected by the telephone number selecting unit.

As a still further preferred feature, the managing apparatus prepares, based on the association managed by the managing unit, reproduction information, in the form of web data placed on the Internet, that an e-mail message which is addressed to the second information terminal, and to which information about sound information is added, has been received from the first information terminal.

As another preferred feature, the text information notifying unit of the managing apparatus prepares a notification e-mail message that contains the text information to be notified to the second information terminal; the telephone number selecting unit of the managing apparatus selects a sound reproduction telephone number for use in reproducing sound on the second information terminal; and the telephone number notifying unit of the managing apparatus adds information about the sound reproduction telephone number, which is selected by the telephone number selecting unit, to the notification e-mail message, which is prepared by the text information notifying unit.

As still another preferred feature, the text information notifying unit of the managing apparatus prepares notification web data to which the second information terminal is accessible, and which web data includes at least the text information received from the first information terminal; the telephone number selecting unit of the managing apparatus selects a sound reproduction telephone number for use in reproducing sound on the second information terminal; and the telephone number notifying unit of the managing apparatus adds information about the sound reproduction telephone number, which is selected by the telephone number selecting unit, to the notification web data, which is prepared by the text information notifying unit.

As a further preferred feature, the e-mail system further comprises an access detecting unit for detecting whether or not access has been made by the second information terminal to the notification web data. If the detection result by the access detecting unit is positive, the telephone number selecting unit selects the sound reproduction telephone number, and the sound information reproducing unit reproduces the sound information to the second information terminal which is connected to the sound reproduction telephone number through audio communication.

Here, the information about the sound reproduction telephone number can be the sound reproduction telephone number itself or an address of a web page indicating the sound reproduction telephone number thereon or a pointer for use in accessing the web page.

As another preferred feature, if the e-mail message, transmitted from the first information terminal to the second information terminal, has information added thereto about the sound information, the managing apparatus further comprises: a sound information obtaining unit for obtaining the sound information based on the information, added to the e-mail message, about the sound information, which sound information obtaining unit then stores the thus-obtained sound information, as the sound information related to the e-mail message, to the sound information storing unit; a sound information reproducing unit for reproducing the sound information stored in the sound information storing unit; and a sound replay unit for replaying the sound information, reproduced by the sound information reproducing unit, through an audio communication channel established by a telephone call made by the calling unit.

As a further preferred feature, the managing apparatus prepares, based on the association managed by the managing unit, reproduction information, as a reproduction information notification e-mail message, that an e-mail message which is addressed to the second information terminal, and to which information about sound information is added, has been received from the first information terminal. Here, the reproduction information notification e-mail message can have a pointer for use in accessing the notification web data.

Further, the e-mail managing apparatus prepares, based on the association managed by the managing unit, reproduction information, in the form of reproduction information notification web data placed on the Internet, that an e-mail message which is addressed to the second information terminal, and to which information about sound information is added, has been received from the first information terminal.

The e-mail system further comprises an identification information setting unit for providing, if there are a plurality of such e-mail messages or. if there are a plurality of such sound information items related to the individual e-mail messages, the individual e-mail messages or the individual sound information items with identification information for identifying the e-mail messages or the sound information items. The managing unit manages association among the e-mail messages and the sound information items related to the e-mail messages and the identification information provided by the identification information setting unit.

Furthermore, the e-mail system further comprises an identification information inputting unit for inputting such identification information so as to specify the e-mail message or the e-mail-related sound information corresponding to the input identification information.

Moreover, the e-mail system further comprises a sound guidance unit for providing a user of the second information terminal with guidance by voice, and additionally, a web guidance unit for providing a user of the first information terminal or a user of the second information terminal with a web page that shows guidance thereon.

As a generic feature, there is provided a method for transmitting electronic mail (e-mail) message that includes at least text information to be transmitted and received between a first information terminal and a second information terminal, which first information terminal transmits and receives sound information and text information, and which second information terminal transmits and receives sound information and text information in different ways. The method comprises the steps of: notifying the second information terminal of the text information included in the e-mail message; storing sound information related to the e-mail message; and managing association between the e-mail message and the sound information related to the e-mail message.

As another generic feature, there is provided an information processing apparatus, communicably interconnected between a first information terminal for transmitting and receiving sound information and text information and a second information terminal for transmitting and receiving sound information and text information in different ways, for managing an electronic mail (e-mail) message, including at least text information, transmitted and received between the first information terminal and the second information terminal. The information processing apparatus comprises: a text information notifying unit for notifying the second information terminal of the text information included in the e-mail message; a sound information storing unit adapted to store sound information related to the e-mail message; and a managing unit for managing association between the e-mail message and the sound information related to the e-mail message.

As still another generic feature, there is provided an electronic mail (e-mail) managing program which instructs a computer to function as an information processing apparatus, communicably interconnected between a first information terminal transmitting and receiving sound information and text information and a second information terminal transmitting and receiving sound information and text information in different ways, for managing an e-mail message, including at least text information, transmitted and received between the first information terminal and the second information terminal. The information processing apparatus comprises: a text information notifying unit for notifying the second information terminal of the text information included in the e-mail message; a sound information storing unit adapted to store sound information related to the e-mail message; and a managing unit for managing association between the e-mail message and the sound information related to the e-mail message.

As a further generic feature, there is provided a computer-readable recording medium storing the foregoing electronic mail (e-mail) managing program thereon.

The e-mail system, the e-mail transmission method, the information processing apparatus, the e-mail managing program, and the computer-readable recording medium storing the e-mail managing program thereon, of the present invention guarantee the following advantageous results.

(1) Since text information contained in an e-mail message is notified to the second information terminal while sound information related to the e-mail message is stored so as to manage the sound information in association with its related e-mail message, it is possible to easily process e-mail messages and sound information on the second information terminal even if it transmits/receives sound information and text information in separate systems.

(2) Since a phone number is provided for use in processing sound information related to an e-mail message which is transmitted from the first information terminal to the second information terminal, it is possible to easily process the sound information on the second information terminal.

(3) Since the phone number of the second information terminal that has been used to call a phone number assigned by the phone number selecting unit, is obtained, and then it is detected whether or not a combination of these phone numbers matches a previously prepared combination, it is possible to easily select an e-mail message to be replied to on the second information terminal.

(4) Since the first information terminal is notified of reply information that a voice reply has been made from the second information terminal, it is possible for a user of the first information terminal to recognize that the voice reply has been made.

(5) Partly since reply information is given in the form of a reply e-mail message, and partly since the reply e-mail message has sound information attached thereto, which sound information has been sent from the second information terminal, or in the form of a pointer for accessing where the sound information is stored, it is possible for a user of the first information terminal to receive the sound information without fail, so that the user's convenience is improved.

(6) Since the reply information is given as web data placed on the Internet, it is easy to process the reply information, so that convenience is improved.

(7) Partly since a notification e-mail message containing text information to be notified to the second information terminal is created, and partly since a phone number to call when the second information terminal inputs any voice sound is given as a sound input phone number, and partly since the information about this sound input phone number is inserted into the notification e-mail message, it is possible to easily notify such a sound input phone number, so that convenience is improved.

(8) Partly since notification web data containing at least text information that has been received from the first information terminal, to which web data the second information terminal is accessible, is created, and partly since a phone number for use in inputting sound from the second information terminal is given as a sound input phone number, and partly since information about the sound input telephone number, which is selected by the telephone number selecting unit, is added to the notification web data, it is possible to easily notify the sound input phone number, so that convenience is improved.

(9) If the e-mail message, transmitted from the first information terminal to the second information terminal, has information added thereto about the sound information, the sound information is obtained based on such information, and the thus obtained sound information is stored as the sound information related to the e-mail message, which sound information can then be replayed on the second information terminal.

(10) The telephone number of the second information terminal from which a telephone call is made to a previously prepared phone number, is obtained, and then, if a combination of the thus obtained phone number and the previously prepared phone number matches a predetermined combination, the sound information is selected as that which is to be reproduced. As a result, it is possible to easily select sound information to be replayed.

(11) Since reproduction information that an e-mail message having information attached thereto about sound information which has been sent from the first information terminal is created as a reproduction information notification e-mail message, it is possible to easily notify the reproduction information, so that convenience is improved.

(12) By means of a sound reproduction phone number indicated in the reproduction information notification e-mail message or by means of a pointer for accessing information indicating the sound reproduction phone number, it is possible to easily notify the sound reproduction phone number, so that convenience is improved.

(13) Since reproduction information that an e-mail message which is addressed to the second information terminal and has information about sound information added thereto, has been sent out from the first information terminal, is placed in the form of web data placed on the Internet, it is possible to easily process the reproduction information, so that convenience is improved.

(14) Partly since a notification e-mail message containing the text information to be notified to the second information terminal is created, and partly since information about the sound reproduction telephone number is added to the notification e-mail message, it is possible for a user of the second information terminal to receive the sound reproduction phone number without fail, so that the convenience for users is improved.

(15) Partly since the text information notifying unit prepares notification web data, including at least the text information received from the first information terminal, to which web data the second information terminal is accessible, and partly since information about the sound reproduction phone number for use in replaying sound data on the second information terminal is added to the notification web data, it is possible for a user of the second information terminal to receive the sound reproduction phone number without fail, so that the convenience for users is improved.

(16) If it is detected that access has been made by the second information terminal to the notification web data, the sound reproduction telephone number is selected, and the sound information is reproduced to the second information terminal which is connected to the sound reproduction telephone number through telephone communication. As a result, it is possible to replay the sound information on the second information terminal with high reliability.

(17) On the basis of association managed in the present system, reproduction information that an e-mail message which is addressed to the second information terminal, and to which information about sound information is added, has been received from the first information terminal, is crated as are production information notification e-mail message. It is thus possible to easily notify the reproduction information, so that convenience is improved.

(18) Since a pointer for accessing notification web data is included in the reproduction information notification e-mail, it is possible to easily access the notification web data, so that convenience is improved.

(19) Reproduction information that an e-mail message which is addressed to the second information terminal, and to which information about sound information is added, has been received from the first information terminal, is created as reproduction information notification web data placed on the Internet. It is thus possible to easily notify the reproduction information, so that convenience is improved.

(20) If there are two or more of such e-mail messages or if there are two or more of such sound information items related to the individual e-mail messages, the individual e-mail messages or the individual sound information items are provided with identification information, and association among the e-mail messages and the sound information items related to the e-mail messages and the identification information is managed. It is thus possible to easily identify an individual e-mail message and its related sound data, so that convenience is improved.

(21) Since such identification information is input to specify the e-mail message or the e-mail-related sound information corresponding to the input identification information, it is possible to easily identify an individual e-mail message and its related sound data, so that convenience is improved.

(22) Since guidance by voice is offered to a user of the second information terminal, the user's convenience is improved.

(23) Since a web page showing guidance thereon is offered to a user of the first information terminal or a user of the second information terminal, the convenience for users is improved.

Other objects and further features of the present invention will be apparent from the following detailed description when read in conjunction with the accompanying drawings.

### BRIEF DESCRIPTION OF THE DRAWINGS

FIG. 1 is a block diagram schematically showing an e-mail system according to a first embodiment of the present invention;

FIG. 2 is a view illustrating an example where a sound-mail associating apparatus of the e-mail system according to the first embodiment of the present invention is placed in an intranet of a company;

FIG. 3 is a view illustrating an example where a sound-mail associating apparatus of the e-mail system according to the first embodiment of the present invention is placed in a mobile carrier;

FIG. 4 is a view illustrating an example screen image shown on a display of a mobile phone, which image shows a notification e-mail message prepared by a mail processing unit of the e-mail system according to the first embodiment;

FIG. 5 is a flowchart showing a process, carried out in the e-mail system according to the first embodiment, of transferring a notification e-mail message notifying about an original mail message that has been received from a PC;

FIG. 6 is a flowchart showing a process, carried out in the e-mail system according to the first embodiment, of replying to the e-mail by voice on the mobile phone;

FIG. 7 is a block diagram schematically showing an e-mail system according to a second, third, or fourth embodiment of the present invention;

FIG. 8 is a view illustrating an example screen image shown on a display of a mobile phone, which image shows a notification e-mail message prepared by a mail processing unit of the e-mail system according to the second embodiment;

FIG. 9 is a flowchart showing a process, carried out in the e-mail system according to the second embodiment, of transferring, to a mobile phone, a notification e-mail message notifying about an original mail message that has been received from a PC;

FIG. 10 is a flowchart showing a process, carried out in the e-mail system according to the second embodiment, of replying to the e-mail by voice on the mobile phone;

FIG. 11 is a flowchart showing a process, carried out in the e-mail system according to the third embodiment, of transferring, to a mobile phone, a notification e-mail message notifying about an original mail message that has been received from a PC;

FIG. 12 is a flowchart showing a process, carried out in the e-mail system according to the fourth embodiment, of preparing notification web data notifying about an original mail message that has been received from a PC;

FIG. 13 is a block diagram schematically showing an e-mail system according to a fifth embodiment of the present invention;

FIG. 14 is a view illustrating an example screen image shown on a display of a mobile phone, which image shows a notification e-mail message prepared by a mail processing unit of the e-mail system according to the fifth embodiment;

FIG. 15 is a flowchart showing a process, carried out in the e-mail system according to the fifth embodiment, of transferring, to a mobile phone, a notification e-mail message notifying about an original mail message that has been received from a PC;

FIG. 16 is a flowchart showing a process, carried out in the e-mail system according to the fifth embodiment, of reproducing sound data on the mobile phone;

FIG. 17 is a block diagram schematically showing an e-mail system according to a sixth, seventh, or eighth embodiment of the present invention;

FIG. 18 is a view illustrating an example screen image shown on a display of a mobile phone, which image shows a notification e-mail message prepared by a mail processing unit of the e-mail system according to the sixth embodiment;

FIG. 19 is a flowchart showing a process, carried out in the e-mail system according to the sixth embodiment, of transferring, to a mobile phone, a notification e-mail message notifying about an original mail message that has been received from a PC;

FIG. 20 is a flowchart showing a process of replaying sound data on the mobile phone in the e-mail system according to the sixth embodiment;

FIG. 21 is a flowchart showing a process, carried out in the e-mail system according to the seventh embodiment, of preparing notification web data notifying about an original mail message that has been received from a PC;

FIG. 22 is a flowchart showing a process, carried out in the e-mail system according to the eighth embodiment, of preparing notification web data notifying about an original mail message that has been received from a PC;

FIG. 23 is a block diagram schematically showing an e-mail system according to a ninth embodiment of the present invention;

FIG. 24 is a flowchart indicating processing performed on a voice reply made from a mobile phone in the e-mail system according to the ninth embodiment of the present invention;

FIG. 25 is a block diagram schematically showing an e-mail system according to a 10th embodiment of the present invention;

FIG. 26 is a flowchart indicating processing performed on a voice reply made from a mobile phone in the e-mail system according to the 10th embodiment of the present invention;

FIG. 27 is a block diagram schematically showing an e-mail system according to an 11th embodiment of the present invention;

FIG. 28 is a flowchart indicating processing performed on a voice reply made from a mobile phone in the e-mail system according to the 11th embodiment of the present invention;

FIG. 29 is a block diagram schematically showing an e-mail system according to a 12th embodiment of the present invention;

FIG. 30 is a flowchart indicating processing performed on a voice reply made from a mobile phone in the e-mail system according to the 12th embodiment of the present invention;

FIG. 31 is a block diagram schematically showing an e-mail system according to a 13th embodiment of the present invention;

FIG. 32 is a flowchart showing a process of replaying sound data on a mobile phone in the e-mail system according to the 13th embodiment;

FIG. 33 is a block diagram schematically showing an e-mail system according to a 14th embodiment of the present invention; and

FIG. 34 is a flowchart showing a process of replaying sound data on a mobile phone in the e-mail system according to the 14th embodiment.

### DESCRIPTION OF THE PREFERRED EMBODIMENT(S)

Preferred embodiments of the present invention will be described hereinbelow with reference to the relevant accompanying drawings.

(A) First Embodiment:

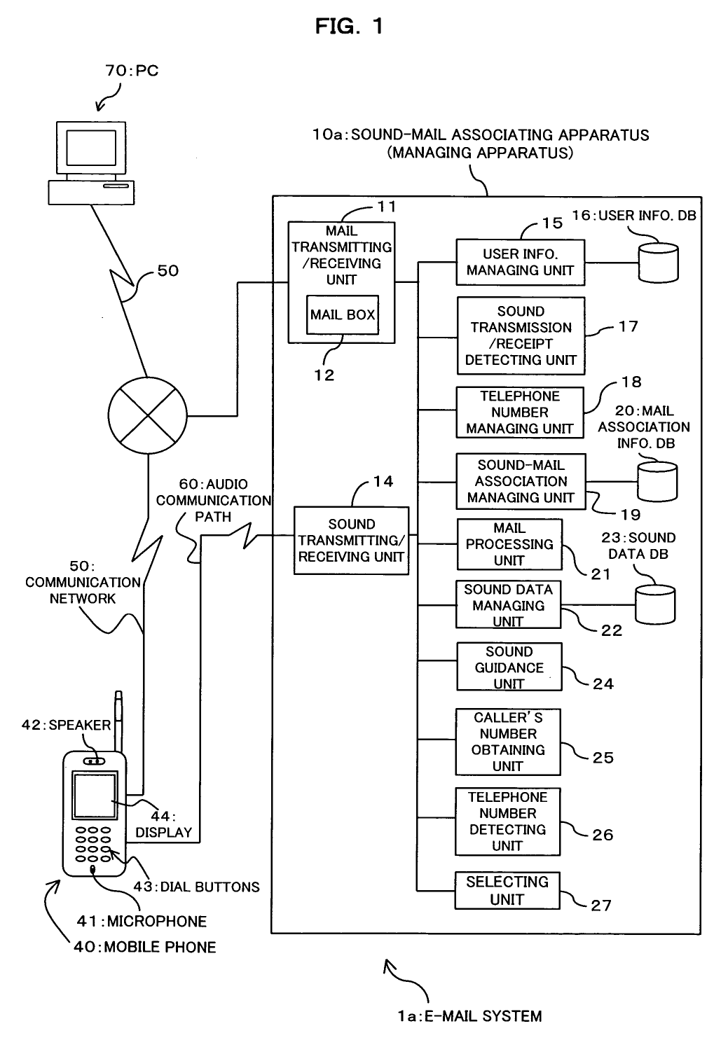

FIG. 1 shows a construction of an electronic mail (e-mail) system in schematic form according to a first preferred embodiment of the present invention. An e-mail system 1a of the first embodiment of FIG. 1 has a PC (Personal Computer: first information terminal) 70, a mobile phone (second information terminal) 40, and a sound-mail associating apparatus (managing apparatus) 10, whereby e-mail is exchanged between the PC 70 and the mobile phone 40.

Hereinafter, description will be made of a case where a user (sender) of the PC 70 sends a user (recipient or destination user) of the mobile phone 40 an e-mail message (original mail message) containing text information, and where the user of the mobile phone 40 replies to the e-mail message on the mobile phone 40 using its telephone communication function.

Strictly speaking, such e-mail is actually transmitted/received between the user of the PC 70 and the user of mobile phone 40. However, for convenience of description, such expressions as e-mail is transmitted/received between the PC 70 and the mobile phone 40 will also be used.

The PC 70 is interconnected with the sound-mail associating apparatus 10a and the mobile phone 40 via a communication network 50 such as the Internet, in such a manner that communication among these is available. The PC 70 stores an application program (mailer), which is run by a CPU (Central Processing Unit; not shown) to create, transmit, and receive e-mail messages.

The PC 70 transmits and receives electronic data and sound data over the communication network 50.

The mobile phone 40 is carried by a user to make telephone calls and data communication thereon. The mobile phone 40 is connected with the PC 70 and sound-mail associating apparatus 10a via the communication network 50, and it is also connected with the sound-mail associating apparatus 10a via an audio communication path 60.

In addition, the mobile phone 40 has not only a function of making/receiving telephone calls but also a function of data communication. However, since the mobile phone 40 employs a line switching system in-which a line is occupied till the end of current communication, it is impossible for users to use both of the two kinds of functions at the same time, so that telephone communication must be terminated before making data communication, and so that data communication must be terminated before starting telephone communication. In other words, the users need to selectively use either one of the functions of telephone communication (audio communication) and data communication as necessary.

The mobile phone 40 uses different communication paths for electronic data communication and sound data communication: the communication network 50 is used for electronic data communication, whereas the audio communication path 60 is used for sound data communication.

The mobile phone 40 is equipped with a microphone (sound information input unit) 41, a speaker 42, dial buttons 43, and a display 44. The microphone 41 is used for inputting voice sound therethrough while the mobile phone 40 serves as a telephone tool, and it also serves as a reply sound input unit through which a voice reply to a received e-mail message is input.

The speaker 42 reproduces voice sound when the mobile phone 40 serves as a telephone tool. The dial buttons 43 are used to input a phone number for making a call when the mobile phone 40 serves as a telephone tool, whereas they are used as an input tool for inputting varying data therethrough when the mobile phone 40 serves as a data communication tool. On its screen, the display 44 shows the contents of an e-mail message transmitted/received as well as character letters input with the dial buttons 43.

The mobile phone 40 makes a call to a predetermined phone number, thereby being connected to the sound-mail associating apparatus 10a through the audio communication path 60 for audio communication.

At this point, if the user wants to access the sound-mail associating apparatus 10a from the mobile phone 40 so as to make audio communication, he inputs information (pass words, or the like) identifying himself and selects various options, following guidance given (described later).

During such audio communication, instructions given through the dial buttons 43 are recognized as tones (sound: analogue signal) assigned to the individual ones of the dial buttons (keys) 43.

When the user accesses the sound-mail associating apparatus 10a from the mobile phone 40 through the communication network 50 for data communication, he inputs information identifying himself and selects various options, following guidance given (described later).

During such data communication, instructions given through the dial buttons 43 are recognized as digital signals assigned to the individual dial buttons (keys) 43.

Then, the user accesses the sound-mail associating apparatus 10a from the mobile phone 40 to transmit an e-mail message prepared by inputting character letters through the dial buttons 43 or to receive an e-mail message sent from the PC 70.

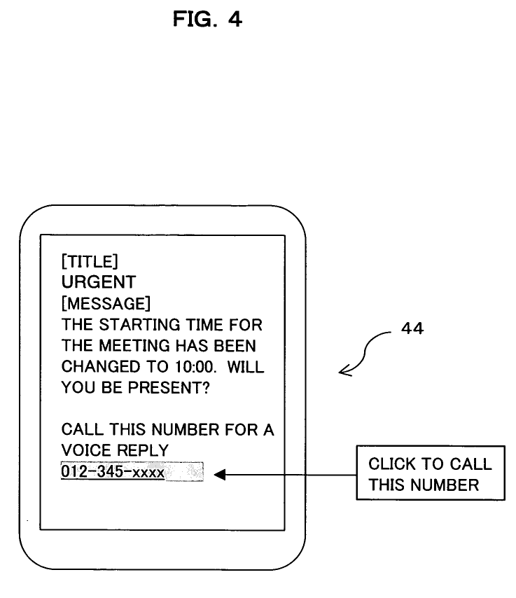

Further, on the mobile phone 40, a phone call is made by inputting a desired phone number with the dial buttons 43. Additionally, if a telephone number is inserted in a received e-mail message or web page, it is possible to call the number by selecting (clicking) the number display indicated in the e-mail message or the web page (see FIG. 4, for example) shown on the display 44 (the PHONE TO function).

Furthermore, an e-mail address is assigned to the mobile phone 40 so that a user can exchange e-mail on the mobile phone 40.

The sound-mail associating apparatus 10a relays e-mail between the PC 70 and the mobile phone 40, and also performs audio communication with the mobile phone 40. As shown in FIG. 1, the sound-mail associating apparatus 10a has a mail transmitting/receiving unit 11, a sound transmitting/receiving unit 14, a user information managing unit 15, a user information DB 16, a sound transmission/receipt detecting unit 17, a telephone number managing unit (telephone number selecting unit) 18, a sound-mail association managing unit (managing unit) 19, a mail association information DB 20, a mail processing unit (telephone number notifying unit) 21, a sound data managing unit 22, a sound data DB (sound information storing unit) 23, a sound guidance unit 24, a caller's number obtaining unit 25, a telephone number detecting unit 26, and a selecting unit 27.

The sound-mail associating apparatus 10a is connected with both the PC 70 and the mobile phone 40 via the communication network 50, and it is connected with the mobile phone 40 via the audio communication path 60.

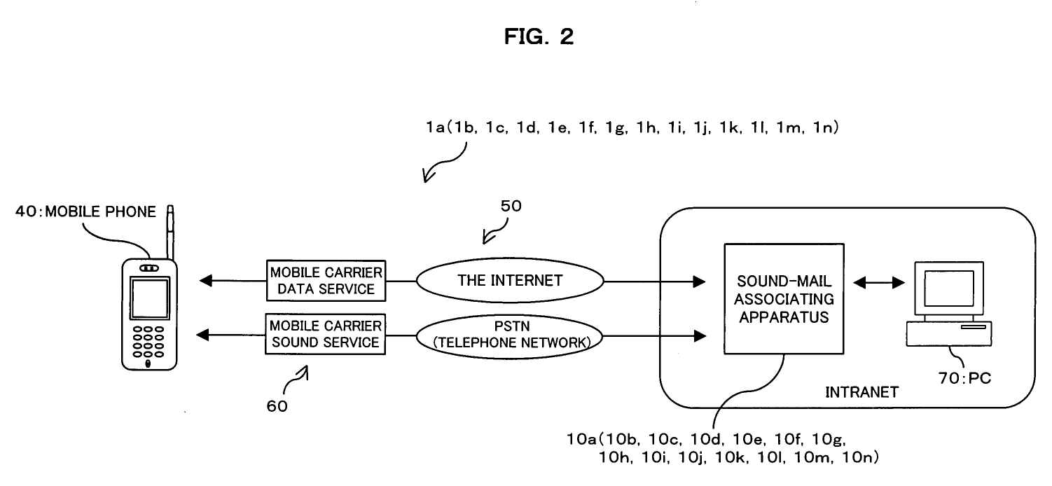

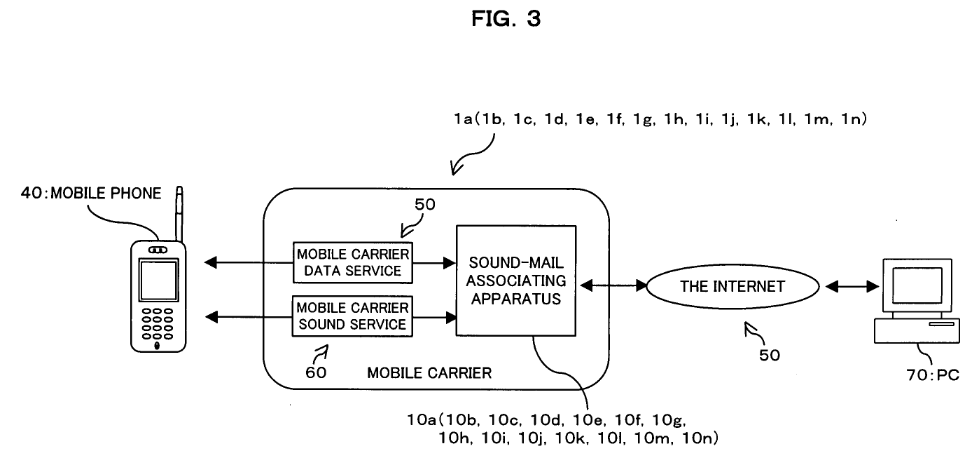

FIG. 2 and FIG. 3 each show an e-mail system 1a according to the first embodiment of the present invention in schematic form. FIG. 2 is an example where the sound-mail associating apparatus 10a is installed in an intranet of a company or the like; FIG. 3 is an example where a sound-mail associating apparatus 10a is installed in a mobile carrier.

As shown in FIG. 2, the sound-mail associating apparatus 10a can be installed in an intranet of a company, and as shown in FIG. 3, it can also be installed in a mobile carrier, which offers mobile phone communication service.

The mail transmitting/receiving unit 11 sends and receives e-mail, and it also manages a mail box 12. In other words, the mail transmitting/receiving unit 11 provides the sound-mail associating apparatus 10a with a function of a mail server.

When the PC 70 sends an e-mail message (hereinafter also called an original mail message or original mail) to the mobile phone 40, the mail transmitting/receiving unit 11 refers to a user information managing unit 15 (described later), based on the destination address of the original mail message, for information about whether or not the user of the destination address hopes that the original mail is transferred to him.

If it is found, as a detection result, that the destination user does not want to receive the original mail, the original mail is stored, as it is, in the mail box 12. Whereas, if the user wants to receive it, the mail transmitting/receiving unit 11 performs processing (described later) for transferring the original mail to the mobile phone 40.

The sound transmitting/receiving unit 14 establishes a telephone call between the mobile phone 40 and the sound-mail associating apparatus 10a, thus making it possible to exchange sound data therebetween. In the first embodiment, such a call is established by making a telephone call (issuing a call) to a specific phone number from the mobile phone 40.

The user information managing unit 15 manages user information stored in the user information DB (Data Base) 16. More specifically, the user information DB 16 stores following types of user information of users of the e-mail system 1a in association with one another: a user ID; a mail address; a mobile phone number, a mobile phone mail address; information about “whether or not mail transfer to a mobile phone is required,” and “whether or not a voice reply to an original mail message is required.” Such information is registered through the user information managing unit 15, which also manages the registered information and retrieves required information items from the user information DB 16, using some of the information items as keys.

Here, such a user ID has previously been assigned to an individual user as a piece of information identifying the user. The mail address is the user's e-mail address that is for use in sending/receiving e-mail on information processing apparatus other than the mobile phone 40. The mobile phone number is a telephone number (caller's phone number) of the user's mobile phone 40, and the mobile phone mail address is an e-mail address given to the mobile phone 40 for sending/receiving e-mail thereon.

The information about “whether or not mail transfer to a mobile phone is required” indicates the necessity for transferring e-mail that is addressed to the user's mail address (other than the one assigned to the mobile phone 40) to the mail address of the mobile phone 40. This information can previously be set by the user of the mobile phone 40.

The information about “whether or not a voice reply to an original mail message is required” indicates whether or not a voice reply is to be made by the user in response to the received e-mail. This information can be previously set by the user of the mobile phone 40.

The sound transmission/receipt detecting unit 17 detects how sound data related to the original mail should be processed. It refers to the user information DB 16 to detect whether or not any sound data needs to be sent from the mobile phone 40 as a reply to the original mail.

On the basis of a value set at the item of “whether or not a voice reply to an original mail message is required” in the user information DB 16, which is managed by the user information managing unit 15, the sound transmission/receipt detecting unit 17 detects whether or not it is required to receive sound data from the mobile phone 40.

The sound data managing unit 22 registers and manages sound data that has been received from the mobile phone 40. When the mobile phone 40 transmits sound data, that is, when a voice reply is made to the original mail from the mobile phone 40, the sound data managing unit 22 stores the sound data, received by the sound transmitting/receiving unit 14, to the sound data DB 23 for managing the data, and notifies a sound-mail association managing unit 19 (described later) of information (URL (Uniform Resource Locator) or the like) where the sound data is stored.

The telephone number managing unit 18 selects (sets) one of the dedicated telephone numbers (voice input phone numbers) that has been previously prepared for sound data transmission/receipt, in association with the original mail to be replied to. In the first embodiment, if there are two or more original mail messages addressed to the user, to which messages the user wants to reply, the telephone number managing unit 18 selects different voice input phone numbers, one for each of the original messages.

On the selection of the sound input phone numbers, the telephone number managing unit 18 obtains the phone number (caller's phone number) of the recipient user's mobile phone from the user information managing unit 15, based on a mail address of the recipient. The telephone number managing unit 18 then manages the obtained phone number and the selected voice input phone number in association with each other.

The sound-mail association managing unit 19 associates such e-mail (original mail, notification e-mail, and reply mail) with its relevant sound data. It stores information (association) for associating the sound data and the e-mail in the mail association information DB 20, and additionally, it also retrieves the thus-registered information in the mail association information DB 20 as required.

The mail association information DB 20 stores the user ID of a recipient of each original mail message, the mobile phone number of the recipient, a sound input phone number, a location of sound data, and the contents (header and message body) of the original message, in association with one another.

At that time, the sound input phone number is a telephone number selected by the telephone number managing unit 18; the location of sound data to be transmitted is where sound data input from the mobile phone 40 is stored. As the contents of the original mail, its header and message body (text information) are subjected to management.

The user information managing unit 15 obtains the user ID of the recipient of the original mail and also his mobile phone number, by using the e-mail address which the original mail is addressed to as a key.

The mail processing unit 21 processes e-mail messages. On the basis of the message body (text information) of an original e-mail message, the mail processing unit 21 prepares an e-mail message (hereinafter also called a notification e-mail message) to notify the mobile phone 40 of the original mail, thereby serving as a text information notifying unit.

In order to notify the mobile phone 40 of a sound input phone number selected by the telephone number managing unit 18, the mail processing unit 21 inserts the phone number itself into the thus-prepared notification e-mail, thereby serving as a telephone number notifying unit.

FIG. 4 is an example screen image shown on the display 44 of the mobile phone 40, which image indicates a notification e-mail message prepared by the mail processing unit 21. In this example, the sound input phone number itself is inserted into the message body of the notification e-mail message.

The mail processing unit 21 prepares such a notification e-mail message as shown in FIG. 4. At preparation of the notification e-mail, the mail processing unit 21 provides each piece of such notification e-mail with a header prepared based on the header of the original mail. For instance, the mail processing unit 21 uses the address of the sender of the original mail as a description for the “FROM” section of the header of the notification e-mail; the mail address of the recipient's mobile phone 40, for the “TO” section; a description of the subject of the original mail, for the “SUBJECT” section.

If the user of the mobile phone 40 makes a voice reply to the sender of the original mail, the mail processing unit 21 prepares an e-mail message (reply e-mail) which informs the sender that sound data has been sent from the mobile phone 40 as a reply, thereby serving as a reply information notifying unit.

The mail processing unit 21 prepares a reply e-mail message based on information obtained from the user information managing unit 15 and the sound-mail association managing unit 19. At reparation of the reply e-mail, the mail processing unit 21 also provides each piece of such reply e-mail with a header prepared based on the header of the original mail. For instance, the mail processing unit 21 utilizes the mail address of the user who makes a voice reply, or the recipient of the original mail, as a description for the “FROM” section of the header of the reply e-mail; the mail address of the sender of the original mail, for the “TO” section; a description of the subject of the original mail with an expression of “RE:” attached at its leading end, for the “SUBJECT” section; a Message-ID value of the original mail, for the “REFERENCES” section.

Further, the mail processing unit 21 adds sound data itself, having been input through the microphone 41 of the mobile phone 40, to the reply e-mail as an attached file, or alternatively, it also adds a pointer (a URL or the like), for accessing where (sound data DB 23) the sound data is stored, to the reply e-mail.

It can be left to the user to decide which one of the sound data itself and the pointer for accessing the sound data is to be attached to the reply e-mail. In this case, it is preferred that the user's choice is registered in the user information DB 16.

The sound guidance unit 24 offers guidance on a variety of operations to the user of the mobile phone 40, thereby serving as a sound guidance unit. More precisely, the sound guidance unit 24 notifies the mobile phone 40, which has established audio communication with the sound transmitting/receiving unit 14, of, for example, timing for pushing the dial button 43 or for inputting voice sound, and which one of the dial buttons 43 is to be pressed down.

The caller's number obtaining unit 25 obtains the telephone number of the mobile phone 40 on which a telephone call has been made to the number predetermined by the telephone number managing unit 18. The number can be obtained by utilizing the number display function of the mobile phone 40 or by instructing a user to input the number of the mobile phone 40.

The telephone number detecting unit 26 detects whether or not a combination of the sound input phone number selected by the telephone number managing unit 18 and the phone number (caller's number) obtained by the caller's number obtaining unit 25 matches a predetermined combination managed by the telephone number managing unit 18. The detection result is then notified to the selecting unit 27.

If the above detection result is positive, the selecting unit 27 selects an original mail message corresponding to the sound input phone number.

Since the selecting unit 27 evaluates the combination of the caller's number of the mobile phone 40 and the sound input phone number, it is still possible to easily recognize an original mail message to which a reply is to be made, even if there is more than one original mail message that is addressed to the user.

In the e-mail system la of the first embodiment of the present invention, after an original mail message is sent from the PC 70 to a recipient's mail address, the mail processing unit 21 creates a notification e-mail message (see FIG. 4) that informs about the sent-out original mail, and the mail transmitting/receiving unit 11 sends out the thus-created notification e-mail addressed to the mail address of the mobile phone 40. The user of the mobile phone 40, on which the notification e-mail has been received, makes a reply, by sound data, to the PC 70 from the mobile phone 40.

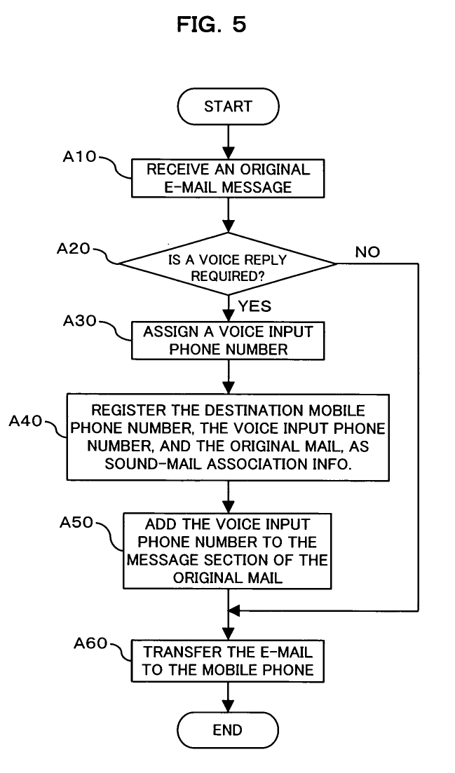

Referring to the flowchart (step A10 through step A60) of FIG. 5, a description will be made hereinbelow of processing performed in the e-mail system la according to the first embodiment of the present invention when a notification e-mail message is transferred to the mobile phone 40 for informing about the original mail transmitted from the PC 70.

The mail transmitting/receiving unit 11 of the sound-mail associating apparatus 10a receives the original mail transmitted from the PC 70 (Step A10). The sound transmission/receipt detecting unit 17 inquires of the user information managing unit 15 whether or not a voice reply is required to the original mail, using the destination address of the original mail as a key (step A20).

At this point, if there is no necessity for such a voice reply (NO route of Step A20), the destination address of the original mail is replaced with the mail address of the mobile phone 40, and the original mail, whose destination address has been rewritten, is then transferred to the mail address of the mobile phone 40 (step A60), and the processing ends.

On the other hand, if a voice reply (YES route of step A20) is required, the telephone number managing unit 18 assigns the original mail a sound input phone number (step A30). On the basis of the recipient's mail address, to which the original mail is addressed, the sound-mail association managing unit 19 obtains the phone number of the recipient's mobile phone 40 from the user information managing unit 15. The sound-mail association managing unit 19 associates the thus-obtained mobile phone number, the sound input phone number, and the original mail with one another, and then stores the association (association information) in the mail association information DB 20 (step A40).

The mail processing unit 21 obtains the message body of the original mail, to which the mail processing unit 21 then inserts the sound input phone number, thereby creating a notification e-mail message (step A50). The mail transmitting/receiving unit 11 transfers the thus-created notification e-mail to the mobile phone 40 (step A60).

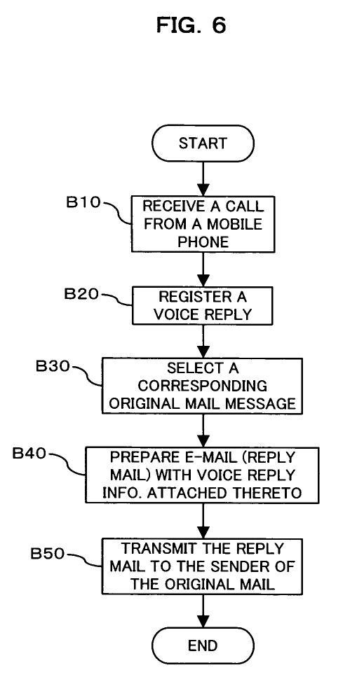

Referring to the flowchart (step B10 through step B50) of FIG. 6, a description will be made hereinbelow of processing performed in the e-mail system 1a according to the first embodiment of the present invention, when a user makes a voice reply on the mobile phone 40.

The user of the mobile phone 40 receives such notification e-mail on the mobile phone 40, thereby being notified of what is written in the original mail. If the user of the mobile phone 40 wants to make a voice reply to the original mail, he selects the phone number inserted in the message body, thereby making a call to the number with the PHONE TO function. The sound-mail associating apparatus 10a receives the telephone call made from the mobile phone 40 (step B10).

Following voice guidance offered by the sound guidance unit 24, the user inputs a voice reply to the original mail through the microphone 41 of the mobile phone 40, and the sound data managing unit 22 stores the input sound data to the sound data DB 23 (step B20).

Here, the caller's number obtaining unit 25 obtains the caller's number of the mobile phone 40 on which a call has been made to the sound input phone number. The telephone number detecting unit 26 detects whether or not a combination of the caller's phone number obtained by the caller's number obtaining unit 25 and the sound input phone number selected by the telephone number managing unit 18 matches a combination managed by the telephone number managing unit 18. The selecting unit 27 then selects an original mail message corresponding to this phone number combination as a message to be replied (step B30) to.

The mail processing unit 21 prepares a reply e-mail message to the thus-selected original mail (step B40). The mail processing unit 21 attaches sound data input by the user through the microphone 41 of the mobile phone 40 to the reply e-mail without carrying out any processing on it, or alternatively, the mail processing unit 21 adds a pointer allowing access where the sound data is stored to the replay e-mail.

The reply e-mail thus prepared by the mail processing unit 21 is sent out from the mail transmitting/receiving unit 11 to the sender of the original mail (step B50).

In this manner, with the e-mail system la according to the first embodiment of the present invention, it is possible for the user of the mobile phone 40 to reply to the e-mail (original mail), received by the mobile phone 40, by voice sound. As a result, the necessity for inputting complicated character letters through the dial buttons 43 of the mobile phone 40 is eliminated, thus improving convenience.

Further, it is possible for the addressee of the reply e-mail, or the sender of the original mail, to cope with the original mail he sends out and its reply e-mail (including sound data) he receives, in association with each other, as in the case of a common e-mail message and its reply e-mail message, so that management of a history of e-mail transmission/receipt is facilitated, thereby improving convenience.

Furthermore, even if a circuit switching system is employed, in which a line is occupied until current communication is completed so that data communication and audio communication (voice communication) cannot be performed at the same time, it is still possible to cope with e-mail and sound data, transmitted/received in the system, in an integrated manner, thereby improving convenience.

Moreover, since it is possible to easily call the sound input phone number by using the PHONE TO function, the user does not need to remember the sound input phone number, so that convenience is improved.

(B) Second Embodiment:

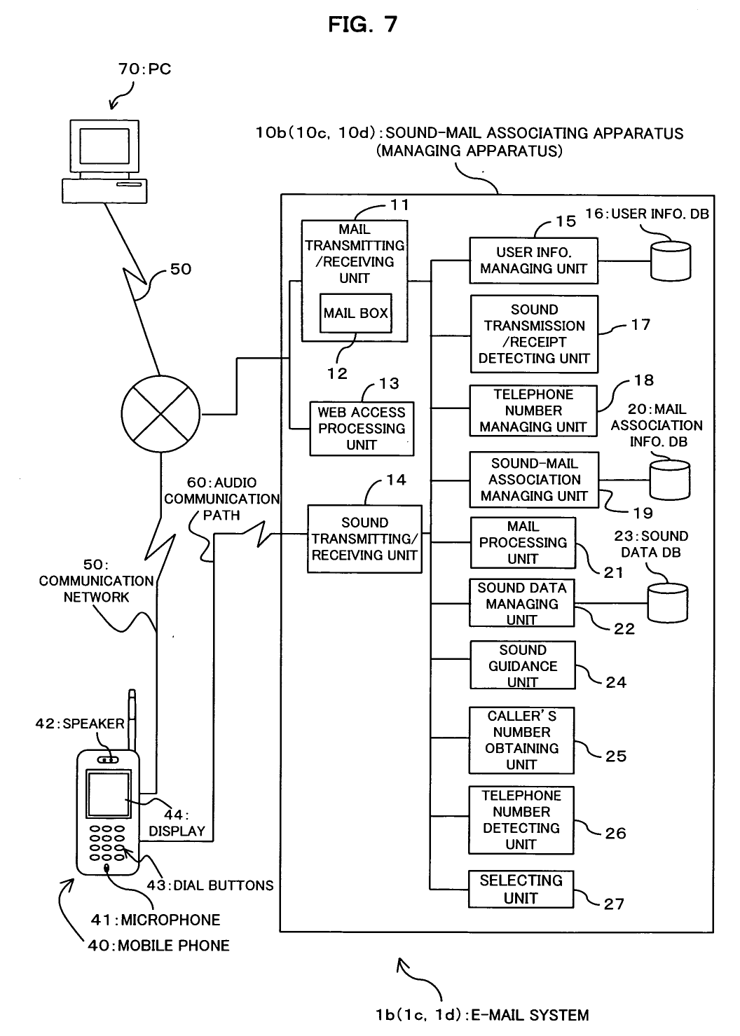

FIG. 7 shows a construction of an electronic mail (e-mail) system, in schematic form, according to a second preferred embodiment of the present invention. In the following description, like reference numbers and characters designate similar parts or elements throughout several views of the present embodiment and the conventional art, so their detailed description is omitted here.

Like the e-mail system 1a of the first embodiment, an e-mail system 1b of the second embodiment of FIG. 7 is for transmitting/receiving e-mail between the user of the PC 70 and the user of the mobile phone 40, and the e-mail system 1b has a sound-mail associating apparatus 10b in place of the sound-mail associating apparatus 10a of the e-mail system 1a (see FIG. 1) of the first embodiment.

The sound-mail associating apparatus 10b has the same construction as that of the sound-mail associating apparatus 10a with a web access processing unit 13 additionally provided thereto.

The web access processing unit 13 creates a web page (sound-input phone number notification page) on which a sound input phone number selected by the telephone number managing unit 18 is shown, and provides the thus-created sound-input phone number notification page so that the mobile phone 40 can access it through the communication network 50. That is, the web access processing unit 13 has a function of a so-called web server.

In the second embodiment, the web access processing unit 13 serves as a telephone number notifying unit, which notifies the mobile phone 40 of the phone number selected by the telephone number managing unit 18.

In addition, the sound transmitting/receiving unit 14 of the e-mail system 1b of the second embodiment manages the device number of the mobile phone 40 in association with the user ID of its user. As the device numbers are previously assigned, one to each mobile phone 40, it can serve as a type of identification information for identifying the individual mobile phones 40.

The mail association information DB 20 stores the following items in association with one another: the user ID of a recipient of an individual original mail message; the mobile phone number of the recipient; the device number of the recipient's mobile phone; a sound input phone number; a place where sound data is stored; and contents (header and message) of the original message. In addition, the mail association information DB 20 also stores the association therein.

The web access processing unit 13 offers a web page showing various kinds of guidance thereon to the PC 70 and the mobile phone 40 that access the web page through the communication network 50, thereby serving as a web guidance unit.

In order to notify the mobile phone 40 of a sound input phone number selected by the telephone number managing unit 18, the mail processing unit 21 inserts a pointer (a URL or the like, for example), instead of a sound input phone number itself, for accessing a sound-input phone number notification page that has been previously prepared by the web access processing unit 13, to the message body of the notification e-mail.

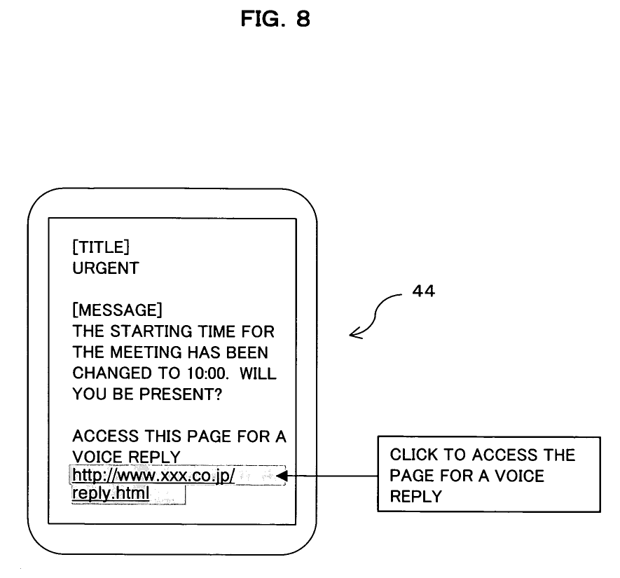

FIG. 8 is an example screen image shown on the display 44 of the mobile phone 40, in which image a notification e-mail message prepared by the mail processing unit 21 is indicated. In this example, a link tag (pointer) for accessing a sound-input phone number notification page is inserted to the message body of the notification e-mail message. In the second embodiment, the mail processing unit 21 creates such a notification e-mail message as that shown in FIG. 8.

The sound-mail association managing unit 19 of the sound-mail associating apparatus 10b of the second embodiment obtains the device number of the recipient's mobile phone 40 from the user information managing unit 15, based on a mail address to which the received original mail is addressed. The sound-mail association managing unit 19 associates the device number and the original mail and then stores (registers) the association (association information) to the mail association information DB 20.

Further, the mobile phone 40 of the second embodiment has browser software with which a web page offered by the sound-mail associating apparatus 10b can be viewed, and web data is shown on the display 44 of the mobile phone 40. If a received e-mail message or a received web page contains a link tag (pointer) therein, it is possible to access a web page or data linked with the link tag, by simply selecting (clicking) the link tag shown on the display 44 (see FIG. 8) (the Web TO function).

In the e-mail system 1b as constructed above, after an original mail message is sent from the PC 70 to a destination (recipient's) mail address, the mail processing unit 21 creates a notification e-mail message (see FIG. 8) that informs about the sent-out original mail, and the mail transmitting/receiving unit 11 sends out the thus-created notification e-mail to the mail address of the mobile phone 40. The user of the mobile phone 40, on which the notification e-mail has been received, makes a voice reply to the PC 70 on the mobile phone 40.

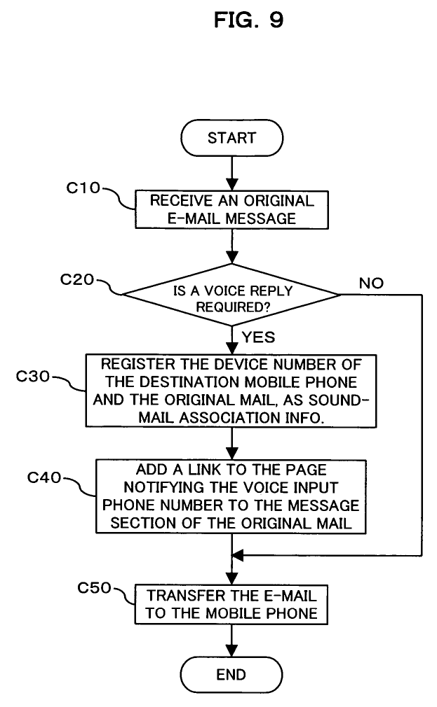

Referring to the flowchart (step C10 through step C50) of FIG. 9, a description will be made hereinbelow of processing performed in the e-mail system 1b according to the second embodiment of the present invention when a notification e-mail message is transferred to the mobile phone 40 to inform about the original mail transmitted from the PC 70.

The mail transmitting/receiving unit 11 of the sound-mail associating apparatus 10b receives an original mail message addressed to a recipient from the PC 70 (Step C10). The sound transmission/receipt detecting unit 17 inquires of the user information managing unit 15 whether or not a voice reply is required to the original mail, using a destination address of the original mail as a key (step C20).

At this point, if there is no necessity for such a voice reply (NO route of Step C20), the destination address of the original mail is replaced with the mail address of the recipient's mobile phone 40, and the original mail, whose destination address has been rewritten, is then transferred to the mail address of the mobile phone 40 (step C50), and the processing ends.

On the other hand, if a voice reply (YES route of step C20) is required, the sound-mail association managing unit 19 obtains the device number of the mobile phone 40 from the user information managing unit 15, based on the destination address to which the original mail is addressed. The sound-mail association managing unit 19 then associates the thus-obtained device number and the original mail with each other, and stores (registers) the association (association information) in the mail association information DB 20 (step C30).

The mail processing unit 21 obtains the message body of the original mail, to which the mail processing unit 21 then inserts a link tag for accessing a sound-input phone number notification page, thereby creating a notification e-mail message (step C40). The mail transmitting/receiving unit 11 transfers the thus-created notification e-mail to the mobile phone 40 (step C50).

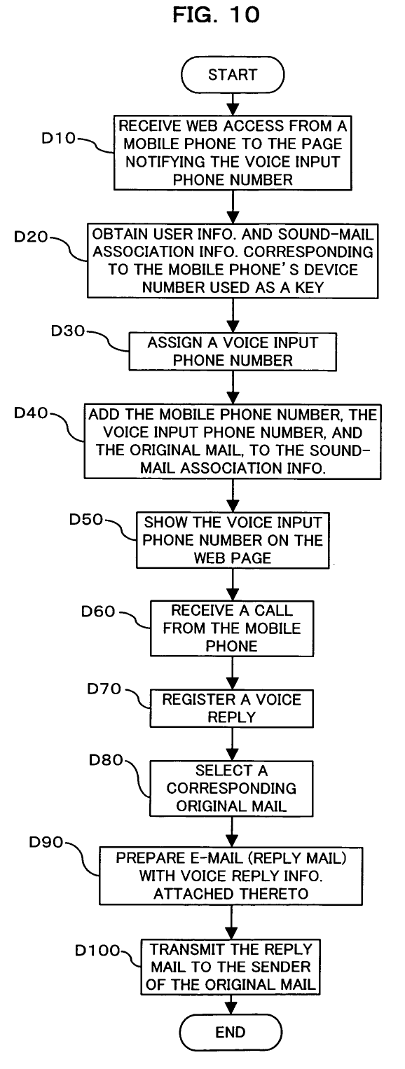

Next, referring to the flowchart (step D10 through step D100) of FIG. 10, a description will be made hereinbelow of processing performed in the e-mail system 1b according to the second embodiment of the present invention, when a user makes a voice reply on the mobile phone 40.

The user of the mobile phone 40 receives such notification e-mail on the mobile phone 40, thereby being notified of the message body contained in the original mail. If the user wants to make a voice reply to the original mail, he selects (clicks) the link tag inserted in the message body of the notification e-mail (see FIG.8), thereby accessing a sound input phone number notification page with use of the Web TO function. The sound-mail associating apparatus 10b hereby receives the access to the second input phone number notification page from the mobile phone 40 (step D10).

The sound-mail associating apparatus 10b obtains the device number of the mobile phone 40 that has accessed the sound-input phone number notification page, and on the basis of the thus-obtained device number, the sound-mail associating apparatus 10b obtains user information of the user of the mobile phone 40 from the user information managing unit 15 (step D20).

The telephone number managing unit 18 assigns a sound input phone number for this access to the sound-input phone number notification page (step D30), and the sound-mail association managing unit 19 associates the phone number (caller's number) of the mobile phone 40, the sound input phone number, and the original mail with one another, and then stores the association information in the mail association information DB 20 (step D40). The web access processing unit 13 shows the sound input phone number selected by the telephone number managing unit 18 on the sound-input phone number notification page (step D50).

After that, the user selects the sound input phone number thus displayed on the display 44 of the mobile phone 40, thereby making a phone call to the sound input phone number with the PHONE TO function of the mobile phone 40, which call is then received by the sound transmitting/receiving unit 14 (step D60). Upon receipt of the user's reply to the original mail by voice sound through the microphone 41 of the mobile phone 40, the sound data managing unit 22 stores the thus-input sound data to the sound data DB 23 (step D70).

Here, the caller's number obtaining unit 25 obtains the caller's number of the mobile phone 40 on which a call has been made to the sound input phone number. The telephone number detecting unit 26 detects whether or not a combination of the caller's phone number obtained by the caller's number obtaining unit 25 and the sound input phone number selected by the telephone number managing unit 18 matches a combination managed by the telephone number managing unit 18. The selecting unit 27 then selects an original mail message corresponding to this phone number combination as a message to be replied to (step D80).

The mail processing unit 21 prepares a reply e-mail message to the thus-selected original mail (step D90). The mail processing unit 21 attaches sound data input by the user through the microphone 41 of the mobile phone 40 to the reply e-mail without making any processing on it, or alternatively, the mail processing unit 21 adds a pointer for accessing where the sound data is stored to the replay e-mail.

After that, the reply e-mail thus prepared by the mail processing unit 21 is sent from the mail transmitting/receiving unit 11 to the sender of the original mail (step D100).

In this manner, with the e-mail system 1b according to the second embodiment of the present invention, not only like effects and benefits to those of the first embodiment are realized, but also the Web TO function facilitates access to a sound input web page, so that the user of the mobile phone 40 does not need to remember or manually input a URL, the convenience for users being thereby enhanced.

(C) Third Embodiment:

Referring to FIG. 7, like the e-mail systems, 1a and 1b, of the first embodiment and the second embodiment respectively, an e-mail system 1c of the third embodiment of the present invention is for transmitting/receiving e-mail between the user of the PC 70 and the user of the mobile phone 40, and the e-mail system 1c has approximately the same construction as that of the e-mail system 1b of the second embodiment.

Instead of a notification e-mail message or a reply e-mail message, which is created by the mail processing unit 21 and transmitted by the mail transmitting/receiving unit 11, the sound-mail associating apparatus 10c employs a web page (web mail) to show contents of the above e-mail messages thereon. Such a web page is offered by the web access processing unit 13.

More specifically, in the third embodiment, the mail processing unit 21 prepares web data (notification web data) containing at least text information of the original mail received from the PC 70, to which web data the mobile phone 40 is accessible through the communication network 50. The web access processing unit 13 presents contents of such a notification e-mail message or a reply e-mail message in such a manner that the PC 70 and the mobile phone 40 can access thereto.

In the e-mail system 1c of the third embodiment, a sound input phone number selected by the telephone number managing unit 18 is inserted to the notification web data. In the following description, a web page formed on this notification web data will sometimes be called a notification web page.

The mail processing unit 21 prepares reply information that a reply has been received from the mobile phone 40 through a sound input phone number, as web data (reply web data) placed on a communication network (the Internet) 50.

This reply web data can have sound data, having been input through the microphone 41 of the mobile phone 40 as a reply to an original mail message, as attached data thereto, or alternatively, it can have a pointer (a URL, or the like) added thereto for accessing a place where the sound data is stored. In the following description, a web page formed on this reply web data will sometimes be called a reply web page.

The sound-mail association managing unit 19 of the sound-mail associating apparatus 10c of the third embodiment manages such notification web data and such a URL of the reply web data, as well as the original mail and the device number of the mobile phone 40, in the mail association information DB 20.

Upon receipt of an original mail message addressed to a recipient's mail address, the mail processing unit 21 creates notification web data about the thus-received original mail, which web data is then presented by the web access processing unit 13 on the communication network 50, as an accessible web page. The recipient sees the notification web page shown on the mobile phone 40 and replies to the PC 70, by sound data, from the mobile phone 40.

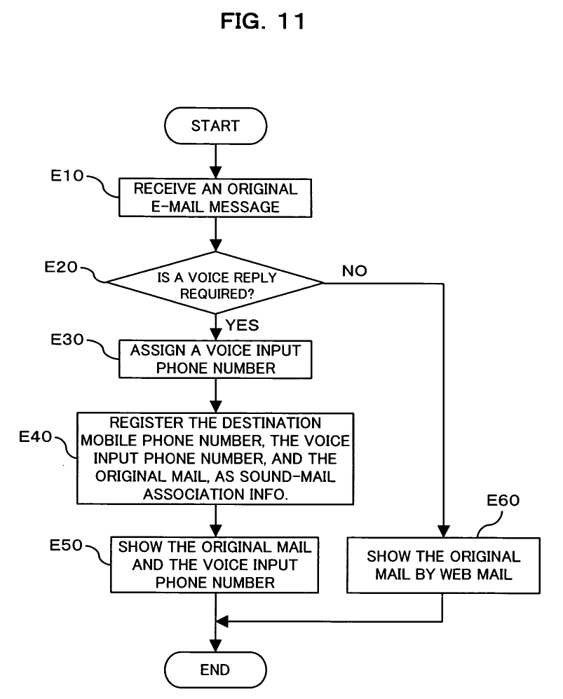

Referring to the flowchart (step E10 through step E60) of FIG. 11, a description will be made hereinbelow of processing performed in the e-mail system 1c according to the third embodiment of the present invention when a notification e-mail message is transferred to the mobile phone 40 to inform about the original mail transmitted from the PC 70.

The mail transmitting/receiving unit 11 of the sound-mail associating apparatus 10c receives the original mail addressed to a recipient from the PC 70 (Step E10). The sound transmission/receipt detecting unit 17 inquires of the user information managing unit 15 whether or not a voice reply is required to the original mail, using the destination address of the original mail as a key (step E20).

At this point, if there is no necessity for such a voice reply (NO route of step E20), the mail processing unit 21 prepares web mail from contents of the original mail, which web mail is then presented on the communication network 50 in an accessible manner (step E60).

On the other hand, if a voice reply (YES route of step E20) is required, the telephone number managing unit 18 assigns the original mail a sound input phone number (step E30). On the basis of the destination address to which the original mail is addressed, the sound-mail association managing unit 19 obtains the phone number of the recipient's mobile phone 40 from the user information managing unit 15. The sound-mail association managing unit 19 associates the thus-obtained phone number, a sound reply phone number, and the original mail with one another, and then stores the association (association information) in the mail association information DB 20 (step E40).

The mail processing unit 21 obtains the message body of the original mail, to which the mail processing unit 21 then inserts a sound input phone number, thereby creating notification web data. The web access processing unit 13 presents a notification web page indicating the message body and the sound input phone number thereon on the communication network 50 in an accessible manner (step E50), and the processing ends.

As for processing performed on a voice reply made from the mobile phone 40 of the e-mail system 1c of the third embodiment, the processing flow is approximately the same as that shown in FIG. 6 except that the user of the mobile phone 40 sees the notification web page on the mobile phone 40, thereby being notified of contents of the original mail, and except that the contents are presented by the web access processing unit 13 as a reply web page, instead of a reply e-mail message being sent from the mail transmitting/receiving unit 11.

In this manner, like effects and benefits to those of the first embodiment are realized by the e-mail system 1c according to the third embodiment of the present invention. In addition, the user of the mobile phone 40 can access the notification web page at his convenience to see the contents of the original mail, so that the convenience for users is increased.

In particular, even in a situation where web pages can be viewed while e-mail transmission/receipt is not available, it is still possible to see the contents of an original mail.

Likewise, the sender of the original mail can access the reply web page at his convenience to see contents of the reply mail, so that the convenience for users is increased.

(D) Fourth Embodiment:

Referring to FIG. 7, like the e-mail systems, 1a, 1b, and 1c, of the first, second, and third embodiments, respectively, an e-mail system 1d of the fourth embodiment of the present invention is for transmitting/receiving e-mail between the user of PC 70 and the user of mobile phone 40, and the e-mail system 1d has approximately the same construction as that of the e-mail system 1b of the second embodiment.

Instead of a notification e-mail message or a reply e-mail message, which is created by the mail processing unit 21 and transmitted by the mail transmitting/receiving unit 11, the sound-mail associating apparatus 10c employs a web page (web mail) to show contents of the above e-mail messages. Such a web page is offered by the web access processing unit 13.

More specifically, in the fourth embodiment, the mail processing unit 21 prepares web data (notification web data) containing at least text information of original mail received from the PC 70, to which web data the mobile phone 40 is accessible through the communication network 50. The web access processing unit 13 presents contents of such a notification e-mail message or a reply e-mail message in an accessible manner.

In order to notify the mobile phone 40 of a sound input phone number selected by the telephone number managing unit 18, a pointer (a URL or a link, or the like), prepared by the mail processing unit 21, for accessing a web page (sound-input phone number notification page) indicating the sound input phone number is inserted into the notification web data. In the following description, the web page formed from this notification web data will also be called a notification web page.

In the above-described e-mail system 1d of the fourth embodiment, when the PC 70 sends-out an original mail message addressed to a recipient's mail address, the mail processing unit 21 creates notification web data about this original mail, which is then presented by the web access processing unit 13 as an accessible notification web page on the communication network 50. The recipient sees the notification web page on the mobile phone 40 and then replies to the PC 70 by sound data on the mobile phone 40.

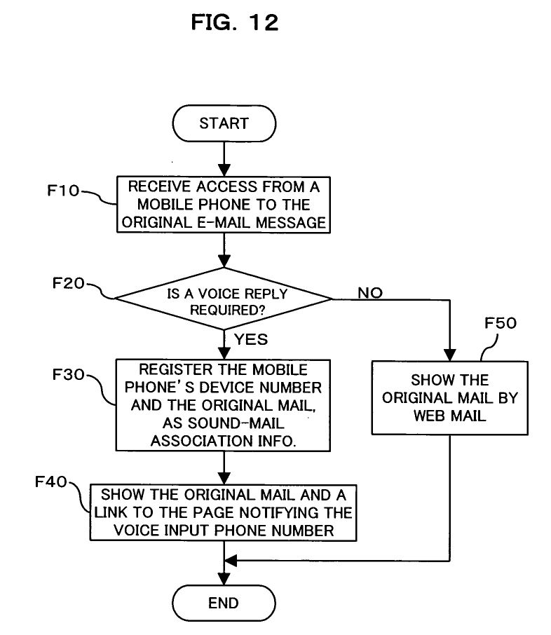

Referring to the flowchart (step F10 through step F50) of FIG. 12, a description will be made hereinbelow of processing for creating such notification web data about original mail transmitted from the PC 70, in the e-mail system 1d according to the fourth embodiment of the present invention.

The mail transmitting/receiving unit 11 receives an original mail message addressed to a recipient from the PC 70 (Step F10). The sound transmission/receipt detecting unit 17 inquires of the user information managing unit 15 whether or not a voice reply is required to the original mail, using the destination address of the original mail as a key (step F20).

At this point, if there is no necessity for such a voice reply (NO route of Step F20), the mail processing unit 21 creates web mail based on contents of the original mail, and the web access processing unit 13 presents the web mail on the communication network 50 in an accessible manner (step F50), and then the processing ends.

On the other hand, if a voice reply (YES route of step F20) is required, the sound-mail association managing unit 19 obtains the device number of the recipient's mobile phone 40 from the user information managing unit 15 based on the destination address of the original mail. The sound-mail association managing unit 19 associates the thus-obtained device number and the original mail with each other and then stores (registers) the association (association information) in the mail association information DB 20 (step F30).

The mail processing unit 21 obtains the message body of the original mail, and inserts a link tag, for accessing a sound-input phone number notification page, to the message body, thereby creating notification web data (web mail). The mail processing unit 21 then presents the web data on the communication network 50 in an accessible manner (step F40), and the processing ends.

As for processing performed on a voice reply made from the mobile phone 40 of the e-mail system 1d of the fourth embodiment, it is approximately the same as that which is described by the flowchart of FIG. 10.

In this manner, like effects and benefits of those of the third embodiment are realized by the e-mail system 1d of the fourth embodiment.

(E) Fifth Embodiment:

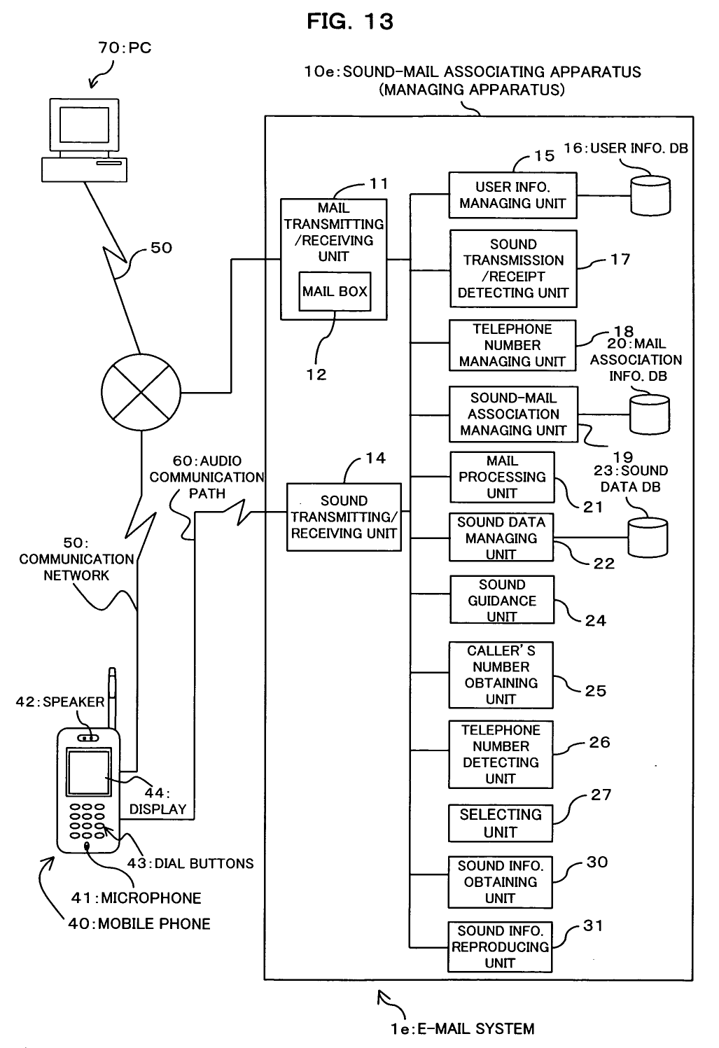

FIG. 13 shows a construction of an electronic mail (e-mail) system in schematic form according to a fifth preferred embodiment of the present invention. An e-mail system 1e of the fifth embodiment of FIG. 13 has a PC (Personal Computer: first information terminal) 70, a mobile phone (second information terminal) 40, and a sound-mail associating apparatus (managing apparatus) 10e, whereby e-mail is exchanged between the PC 70 and the mobile phone 40.

Hereinafter, a description will be made of a case where a user (sender) of the PC 70 sends a user (recipient) of the mobile phone 40 an e-mail message (original mail message) to which information about sound data (sound information) is attached. The user of the mobile phone 40 replays the attached sound data on the mobile phone 40 using its audio communication function. In the following description, like reference numbers and characters designate similar parts or elements throughout several views of the present embodiment and the conventional art, so their detailed description is omitted here.

The sound-mail associating apparatus (managing apparatus) 10e of thee-mail system 1e of the fifth embodiment has the same construction as that of the sound-mail associating apparatus 10a with a sound information obtaining unit 30 and a sound information reproducing unit 31 additionally provided thereto.

In the e-mail system 1e of the fifth embodiment, the user information managing unit 15 stores information about “whether or not sound data needs to be replayed, if any information about the sound data is added to the original mail” as user information, in the user information DB 16 in association with the original mail.

If any sound data is attached to the original mail, the sound transmission/receipt detecting unit 17 inquires of the user information managing unit 15 whether or not the sound data is required to be replayed, thereby determining whether or not the sound data is to be transmitted to the mobile phone 40.

The sound transmission/receipt detecting unit 17 detects, for example, whether or not the received original mail contains information about sound data, that is, sound data itself or a pointer (link) for accessing the sound data, attached thereto. Under the condition the user information DB 16 registers that sound data should be replayed on the mobile phone 40, if a sound file is attached to the original mail, or if a pointer for accessing sound data managed by a sound data managing unit 22 (described later) is shown in the message body of the original mail, the sound transmission/receipt detecting unit 17 recognizes that the sound data is required to be transmitted to the mobile phone 40.

The sound transmitting/receiving unit 14 sends sound data, reproduced by the sound information reproducing unit 31 (described later), by audio communication to the mobile phone 40 that accesses to a sound replay phone number (sound reproduction phone number; described later) through the audio communication path 60.

If the sound transmission/receipt detecting unit 17 detects that information about sound data is added (sound data is associated) to the original mail, the sound information obtaining unit 30 obtains the sound data based on the information about the sound data. The sound information obtaining unit 30 also instructs the sound data managing unit 22 to store and manage the obtained sound data in the sound data DB (sound information storing unit) 23.

For instance, if any sound data is attached to the original mail, the sound information obtaining unit 30 obtains the sound data by duplicating it and stores the copy to the sound data DB 23. If a pointer for accessing the sound data is added to the original mail, the sound information obtaining unit 30 follows the link to download the sound data, and then stores the obtained data in the sound data DB 23.

After that, the sound data managing unit 22 associates the sound data, stored in the sound data DB 23 by the sound information obtaining unit 30, with the original mail for management.

If the original mail contains a pointer for accessing the sound data, the sound data managing unit 22 checks whether or not the pointer is for accessing sound data that has already been registered in the sound data DB 23.

For instance, imagine that e-mail messages are exchanged between two users, A and B, on their mobile phones 40. Upon receipt of an e-mail message from user A, user B replies to the message by sound data, using one of the methods of the foregoing first to fourth embodiments, and user A uses his mobile phone 40 to reproduce the sound data of the reply e-mail (original mail). If the reply mail (original mail) contains a pointer for accessing the sound data, the sound data managing unit 22 checks whether or not the pointer is the one for accessing sound data that has already been registered in the sound data DB 23. As a result, duplicate data in the sound data DB 23 is prevented, thus enabling efficient use of the sound data DB 23.

The sound information reproducing unit 31 efficiently reproduces sound data stored in the sound data DB 23, and it reproduces such sound data in accordance with its data format (WAV, or MP3, for example).

The telephone number managing unit 18 of the fifth embodiment selects (sets) one of the telephone circuits, reserved for sound data transmission/receipt, in association with the original mail to be replied to, as a phone number (sound replay phone number) to call from the mobile phone 40 for listening to the sound data reproduced by the sound information reproducing unit 31.

If the user wants to replay two or more pieces of related sound data, one to each of the original mail messages addressed to the user, the telephone number managing unit 18 provides different sound replay phone numbers, one for each original mail message to be reproduced.

When selecting the sound replay phone number, the telephone number managing unit 18 obtains, from the user information managing unit 15, the phone number (caller's number) of the mobile phone 40 of the user (recipient) to whom the original mail is addressed, based on the destination address of the original mail. The telephone number managing unit 18 manages the thus-obtained phone number in association with the sound replay phone number selected for the original mail.

The mail processing unit 21 processes e-mail messages. It creates an e-mail message (hereinafter sometimes called a notification e-mail) notifying the mobile phone 40 of contents (text information) of the message body of an original mail message.

In order to notify the mobile phone 40 of a sound replay phone number selected by the telephone number managing unit 18, the mail processing unit 21 inserts the selected sound replay phone number itself to the notification e-mail.

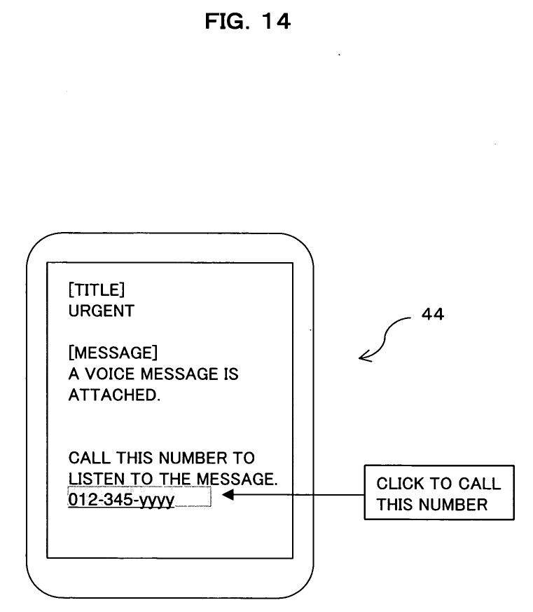

FIG. 14 is an example screen image shown on the display 44 of the mobile phone 40, which image indicates a notification e-mail message prepared by the mail processing unit 21. In this example, the sound replay phone number itself is inserted in the message body of the notification e-mail message.

As in the case of the first embodiment, the mail processing unit 21 of the fifth embodiment also creates a notification e-mail message as shown in FIG. 14. When creating such a notification e-mail message, the mail processing unit 21 provides the notification e-mail with a header in accordance with the header of the original mail. Note that, in the example of FIG. 14, it is possible to call the sound replay phone number, by selecting (clicking) the number indicated in the screen image, with use of the PHONE TO function.

The sound data managing unit 22 registers and manages sound data to be transmitted to the mobile phone 40 or sound data received from the mobile phone 40. When sound data is sent to the mobile phone 40, or when sound data (a sound file) is attached to the original mail, the sound data managing unit 22 stores the sound data in the sound data DB 23 (described later), and also registers information about where {a URL (Uniform Resource Locator) or the like} the sound data is stored in the sound-mail association managing unit 19 to be managed therein.

A user listens to the sound data, which is reproduced by the sound information reproducing unit 31, on the mobile phone 40. The speaker 42 of the mobile phone 40 replays such reproduced sound data, thereby functioning as a sound replay unit, while the mobile phone 40 is accessing the sound transmitting/receiving unit 14 over the audio communication path 60 through the phone number selected by the telephone number managing unit 18.

The telephone number detecting unit 26 detects whether or not a combination of the sound replay phone number selected by the telephone number managing unit 18 and the phone number (caller's number) obtained by the caller's number obtaining unit 25 matches a predetermined combination managed by the telephone number managing unit 18. The detection result is then notified to the selecting unit 27.

If the above detection result is positive, the selecting unit 27 selects an original mail message corresponding to the sound replay phone number.

Since the caller's number obtaining unit 25, the telephone number detecting unit 26, and the selecting unit 27 evaluate the combination of the caller's number of the mobile phone 40 and the sound replay phone number, it is still possible to easily recognize a specific original mail message whose sound data is to be reproduced, even if there is more than one original mail message that is addressed to the user.

In the aforementioned e-mail system 1e of the fifth embodiment of the present invention, after an original mail message is sent from the PC 70 to a recipient's mail address, the mail processing unit 21 creates a notification e-mail message (see FIG. 14) that informs about the sent-out original mail, and the mail transmitting/receiving unit 11 sends out the thus-created notification e-mail to the mail address of the recipient's mobile phone 40. Upon receipt of the notification e-mail on the mobile phone 40, the recipient replays the sound data on the mobile phone 40.

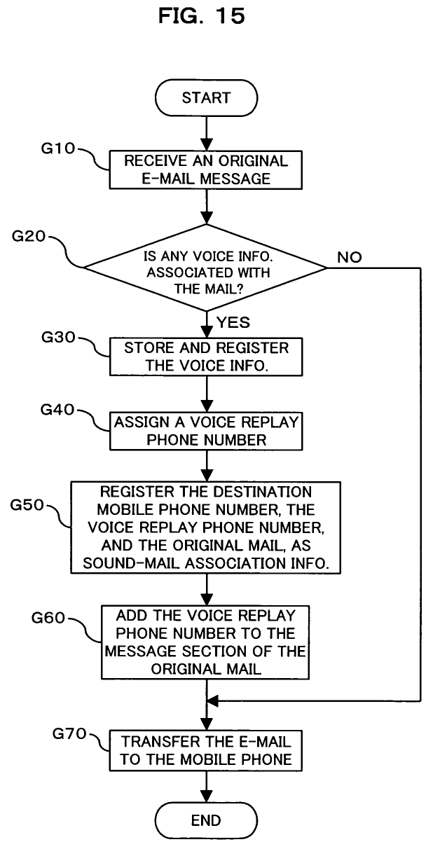

Referring to the flowchart (step G10 through step G70) of FIG. 15, a description will be made hereinbelow of processing performed in the e-mail system 1e according to the fifth embodiment of the present invention when a notification e-mail message is transferred to the mobile phone 40 to inform about the original mail transmitted from the PC 70.

The mail transmitting/receiving unit 11 of the sound-mail associating apparatus 10e receives an original mail message addressed to a recipient from the PC 70 (step G10). The sound transmission/receipt detecting unit 17 inquires of the user information managing unit 15 whether or not sound data associated with the original mail needs to be reproduced, and also whether or not the original mail is associated with any sound data (step G20).

If no sound data is associated with the original mail (NO route of step G20), the destination address of the original mail is replaced with the mail address of the recipient's mobile phone 40, and the original mail is then transferred to the mail address of the mobile phone 40 (step G70), and the processing ends.

If any sound data is associated with the original mail (YES route of step G20), the sound information obtaining unit 30 obtains the sound data, and then stores the sound data in the sound data DB 23 to be managed by the sound data managing unit 22 (step G30).

After that, the telephone number managing unit 18 assigns the original mail a sound replay phone number (step G40). The sound-mail association managing unit 19 obtains the phone number of the mobile phone 40 based on the mail address to which the original mail is addressed, and associates the obtained phone number, the assigned sound replay phone number, and the original mail with one another, and stores the association (association information) in the mail association information DB 20 (step G50).

The mail processing unit 21 obtains the message body of the original mail, to which the mail processing unit 21 then inserts the sound replay phone number, thereby creating a notification e-mail message (step G60). The mail transmitting/receiving unit 11 transfers the thus-created notification e-mail to the mobile phone 40 (step G70).

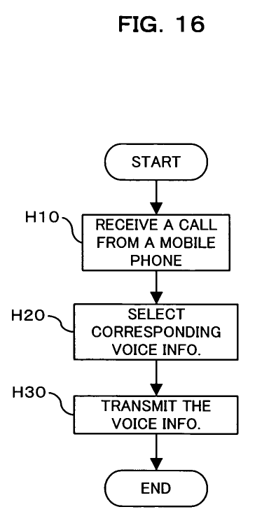

Referring to the flowchart (step H10 through step H30) of FIG. 16, a description will be made hereinbelow of processing performed in the e-mail system 1e according to the fifth embodiment of the present invention, when sound data is replayed on the mobile phone 40.

A user receives such notification e-mail on the mobile phone 40, thereby being notified of the message contained in the original mail. If the user of the mobile phone 40 wants to listen to the sound data associated with the original mail, he selects the phone number inserted in the message body of the notification e-mail (see FIG. 14), thereby making a call to the number using the PHONE TO function. The sound-mail associating apparatus 10e receives the telephone call made from the mobile phone 40 (step H10).

Here, the caller's number obtaining unit 25 obtains the number (caller's number) of the mobile phone 40 on which a call has been made to the sound replay phone number. The telephone number detecting unit 26 detects whether or not a combination of the caller's phone number obtained by the caller's number obtaining unit 25 and the sound relay phone number selected by the telephone number managing unit 18 matches a combination managed by the telephone number managing unit 18. The selecting unit 27 then selects an original mail message corresponding to this phone number combination as a message to be replayed (step H20).

After that, the sound information reproducing unit 31 obtains and reproduces sound data related to the selected original mail from the sound data DB 23 (step H30). The user of the mobile phone 40 listens to the sound data replayed by the speaker 42 of the mobile phone 40, which sound data is received by the sound transmitting/receiving unit 14 through the audio communication path 60.

In this manner, with the e-mail system 1e according to the fifth embodiment of the present invention, it is possible for a user of the mobile phone 40 to use the mobile phone 40 to replay sound data attached to the e-mail (original mail) that has been received by the mobile phone 40, so that the user's convenience is increased.

Further, even if a circuit switching system is employed, in which a line is occupied until current communication is completed so that data communication and audio communication (telephone communication) cannot be performed at the same time, it is still possible to cope with e-mail and sound data, transmitted/received in the system, in an integrated manner, thereby improving convenience.

Furthermore, since it is possible to easily call a sound replay phone number by using the PHONE TO function, the user does not need to remember the sound replay phone number, so that the convenience of users is improved.

(F) Sixth Embodiment:

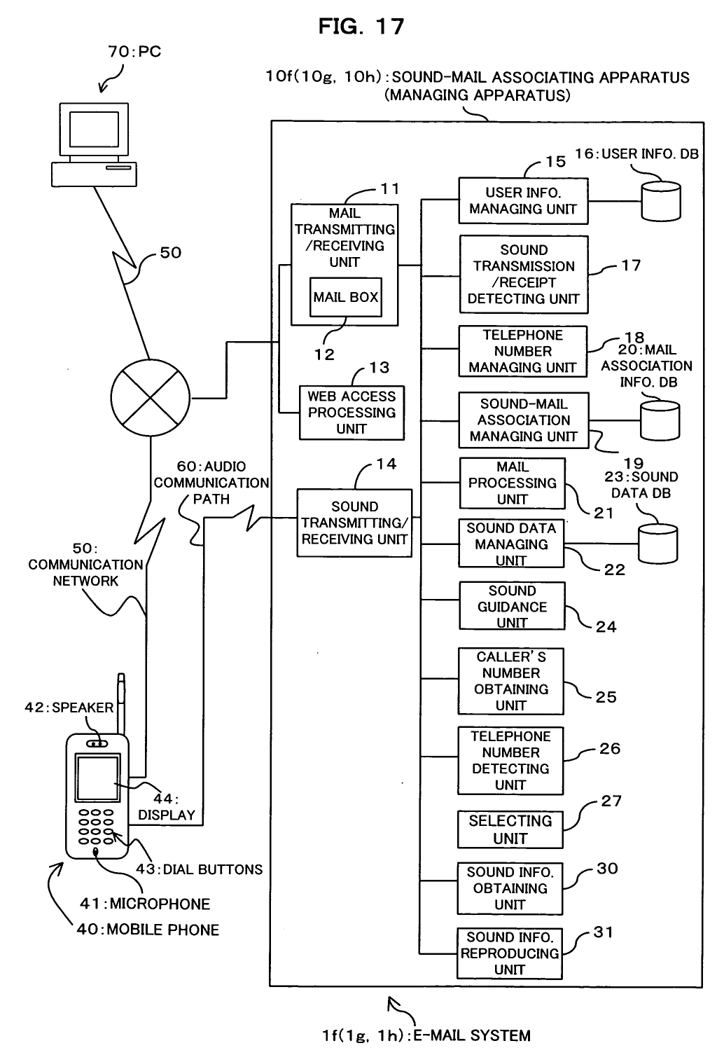

FIG. 17 shows a construction of an electronic mail (e-mail) system, in schematic form, according to a sixth preferred embodiment of the present invention. In the following description, like reference numbers and characters designate similar parts or elements throughout several views of the present embodiment and the conventional art, so their detailed description is omitted here.

Like the e-mail system 1e of the fifth embodiment, an e-mail system 1f of the sixth embodiment of FIG. 17 is for transmitting/receiving e-mail between the user of the PC 70 and the user of the mobile phone 40, and the e-mail system 1f has a sound-mail associating apparatus 10f in place of the sound-mail associating apparatus 10e of the e-mail system 1e (see FIG. 13) of the fifth embodiment.

The sound-mail associating apparatus 10f has the same construction as that of the sound-mail associating apparatus 10e with a web access processing unit 13 additionally provided thereto.

The web access processing unit 13 creates a web page (sound-replay phone number notification page) indicating a sound replay phone number selected (set) by the telephone number managing unit 18 thereon, and offers the thus-created sound-replay phone number notification page in such a manner that the mobile phone 40 can access it through the communication network 50. That is, the web access processing unit 13 carries a function of a so-called web server.

In order to notify the mobile phone 40 of a sound replay phone number selected by the telephone number managing unit 18, the mail processing unit 21 inserts a pointer (a URL or the like, for example), for accessing the sound-replay phone number notification page that has been previously prepared by the web access processing unit 13, into the message body of the notification e-mail.

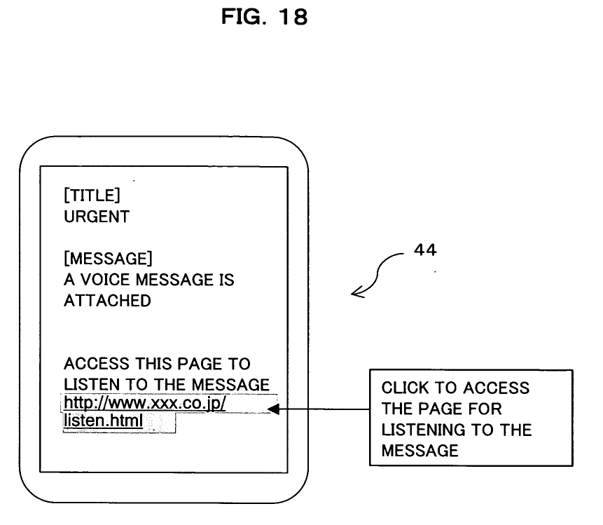

FIG. 18 is an example screen image shown on the display 44 of the mobile phone 40, which image shows a notification e-mail message prepared by the mail processing unit 21. In this example, a link tag (pointer) for accessing a sound-replay phone number notification page is inserted into the message body of the notification e-mail message. In the sixth embodiment, the mail processing unit 21 creates such a notification e-mail message as that shown in FIG. 18.

On the basis of the destination mail address (the recipient's mail address) of the original mail, the sound-mail association managing unit 19 obtains the device number of the recipient's mobile phone 40 from the user information managing unit 15. The sound-mail association managing unit 19 associates the thus-obtained device number and the original mail with each other, and then stores (registers) the association (association information) in the mail association information DB 20.

The mobile phone 40 according to the sixth embodiment also has the Web TO function, thereby making it possible to access a page (sound replay phone number notification page) for reproducing sound data, by simply selecting (clicking) a link tag shown in the notification e-mail of FIG. 18.

In the e-mail system if as constructed above, after an original mail message is sent from the PC 70 to a recipient's mail address, the mail processing unit 21 creates a notification e-mail message (see FIG. 18) that informs about the sent-out original mail, and the mail transmitting/receiving unit 11 sends out the thus-created notification e-mail to the mail address of the recipient's mobile phone 40. The recipient uses the mobile phone 40, on which the notification e-mail has been received, to access the sound-mail associating apparatus 10f through the audio communication path 60 to replay the sound data attached to the original mail.

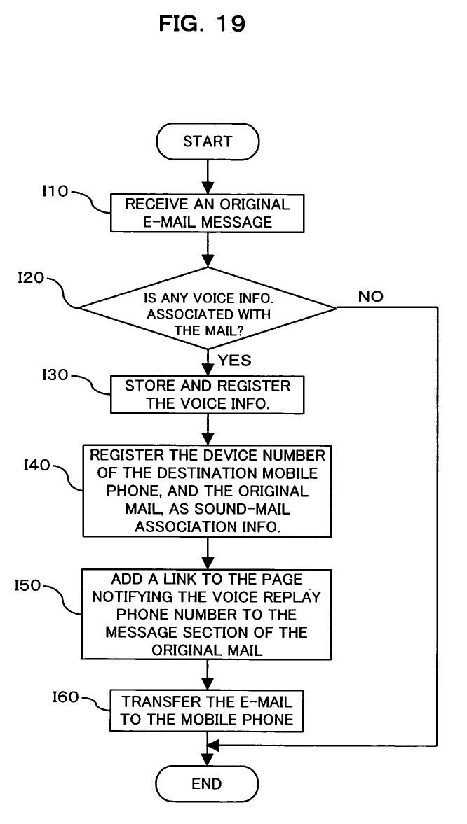

Referring to the flowchart (step I10 through step I60) of FIG. 19, a description will be made hereinbelow of processing performed in the e-mail system 1f according to the sixth embodiment of the present invention when a notification e-mail message is transferred to the mobile phone 40 to inform about an original mail message transmitted from the PC 70.

The mail transmitting/receiving unit 11 of the sound-mail associating apparatus 10f receives an original mail message addressed to a recipient from the PC 70 (step I10). The sound transmission/receipt detecting unit 17 detects whether or not the received original mail contains information about sound data (step I20).

If the above detection result is negative (NO route of step I20), the destination address of the original mail is replaced with the mail address of the recipient's mobile phone 40, and the original mail is then transferred to the mail address of the mobile phone 40 (step I60), and the processing ends.

On the other hand, if the detection result is positive (YES route of step I20), that is, if the original mail contains any information about sound data (sound data itself or a pointer for accessing the sound data), the sound information obtaining unit 30 obtains the sound data and then stores (registers) it in the sound data DB 23 (step I30).

The sound-mail association managing unit 19 obtains the device number of the mobile phone 40 based on the mail address to which the original mail is addressed, and associates the obtained phone number and the original mail with each other, and then stores the association (association information) in the mail association information DB 20 (step I40).

The mail processing unit 21 obtains the message body of the original mail, to which the mail processing unit 21 then inserts a link tag for accessing a sound-replay phone number notification page, thereby creating a notification e-mail message (step I50). The mail transmitting/receiving unit 11 transfers the thus-created notification e-mail to the mobile phone 40 (step I60).

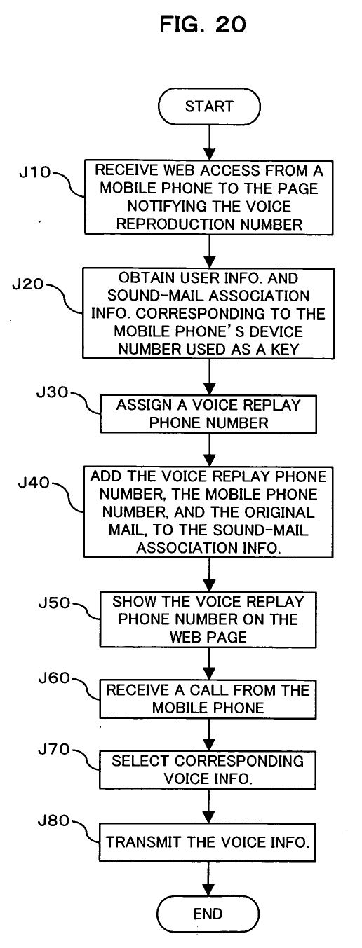

Referring to the flowchart (step J10 through step J80) of FIG. 20, a description will be made hereinbelow of processing performed in the e-mail system 1f according to the sixth embodiment of the present invention, when sound data is replayed on the mobile phone 40.

The user of the mobile phone 40 receives such notification e-mail on the mobile phone 40, thereby being notified of the message contained in the original mail. If the user of the mobile phone 40 wants to listen to the sound data associated with the original mail, he selects the link tag inserted in the message body of the notification e-mail, thereby accessing the sound-replay phone number notification page with use of the Web TO function. The sound-mail associating apparatus 10f receives the access made from the mobile phone 40 to the sound-replay phone number notification page (step J10).

The sound-mail associating apparatus 10f obtains the device number of the mobile phone 40 that accesses the sound-replay phone number notification page, and on the basis of this device number, it then obtains user information about the user of the mobile phone 40 from the user information managing unit 15 (step J20).

The telephone number managing unit 18 assigns a sound replay phone number in response to the user's access to the sound-replay phone number notification page (step J30). The sound-mail association managing unit 19 associates the phone number (caller's number) of the mobile phone 40, the assigned sound replay phone number, and the original mail with one another, and stores the association information in the mail association information DB 20 (step J40). The web access processing unit 13 shows the sound replay phone number selected by the telephone number managing unit 18 on the sound-replay phone number notification page (step J50).

The user selects the sound replay phone number shown on the sound-replay phone number notification page, thereby making a call to the sound replay phone number with use of the PHONE TO function (step J60).

Here, the caller's number obtaining unit 25 obtains the caller's number of the mobile phone 40 on which a call has been made to the sound replay phone number. The telephone number detecting unit 26 detects whether or not a combination of the caller's phone number obtained by the caller's number obtaining unit 25 and the sound relay phone number selected by the telephone number managing unit 18 matches a combination managed by the telephone number managing unit 18. The selecting unit 27 then selects sound data associated with an original mail message corresponding to this phone number combination as that which is to be reproduced (step J70). The sound information reproducing unit 31 reproduces the sound data (step J80), and the processing ends.

In this manner, with the e-mail system 1f according to the sixth embodiment of the present invention, not only like effects and benefits to those of the fifth embodiment are realized, but also the Web TO function facilitates access to a sound reproduction web page, so that the user of the mobile phone 40 does not need to remember or manually input a URL, the convenience for users being thereby increased.

(G) Seventh Embodiment:

Referring to FIG. 17, like the e-mail systems, 1e and 1f, of the fifth embodiment and the sixth embodiment, respectively, an e-mail system 1g of the seventh embodiment of the present invention is for transmitting/receiving e-mail between the user of the PC 70 and the user of the mobile phone 40, and the e-mail system 1g has approximately the same construction as that of the e-mail system 1f of the sixth embodiment.

Instead of a notification e-mail message or a reply e-mail message, which is created by the mail processing unit 21 and transmitted to a recipient's mail address by the mail transmitting/receiving unit 11, the sound-mail associating apparatus 10g employs a web page (web mail) to show the contents of the above e-mail messages thereon. Such a web page is offered by the web access processing unit 13.

More specifically, in the seventh embodiment, the mail processing unit 21 prepares web data (notification web data) containing at least text information of the original mail received from the PC 70, to which web data the recipient can access from the mobile phone 40 through the communication network 50. The web access processing unit 13 presents contents of such a notification e-mail message or a reply e-mail message in such a manner that the PC 70 and the mobile phone 40 can access thereto.

To the above notification web data, the sound replay phone number, selected by the telephone number managing unit 18, is inserted without being processed. In the following description, a web page formed on this notification web data will sometimes be called a notification web page.

The sound-mail association managing unit 19 of the sound-mail associating apparatus 10g according to the seventh embodiment manages not only the original mail and the device number of the mobile phone 40 but also the URL of the notification web data in the mail association information DB 20.

Upon receipt of an original mail message, which is addressed to the recipient's mail address and has sound data associated therewith, from the PC 70, the mail processing unit 21 creates notification web data about the thus-received original mail, which web data is then presented by the web access processing unit 13 on the communication network 50, as an accessible web page. The recipient user sees the notification web page shown on the mobile phone 40 and then listens to the original mail-associated sound data replayed on the mobile phone 40.

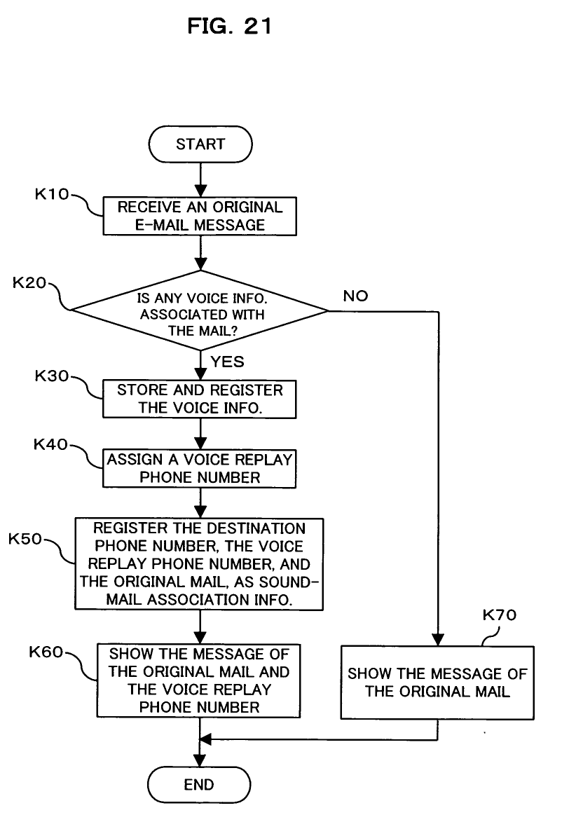

Referring to the flowchart (step K10 through step K70) of FIG. 21, a description will be made hereinbelow of processing performed in the e-mail system 1g according to the seventh embodiment of the present invention when web data on the original mail transmitted from the PC 70 is prepared.

The mail transmitting/receiving unit 11 of the sound-mail associating apparatus 10g receives an original mail message addressed to a recipient from the PC 70 (step K10). The sound transmission/receipt detecting unit 17 detects whether or not the received original mail is associated with any sound data (step K20).

If the above detection result is negative (NO route of step K20), the web access processing unit 13 and the mail processing unit 21 create web mail based on contents of the original mail, and then presents the web mail on the communication network 50 in an accessible manner (step K70), and then the processing ends.

On the other hand, if the detection result is positive (YES route of step K20), the sound information obtaining unit 30 obtains the sound data attached to the original mail, and then stores the sound data in the sound data DB 23 to be managed by the sound data managing unit 22 (step K30).

After that, the telephone number managing unit 18 assigns a sound replay phone number to the original mail (step K40). The sound-mail association managing unit 19 obtains the phone number of the recipient's mobile phone 40 based on the mail address to which the original mail is addressed, and associates the obtained phone number, the assigned sound replay phone number, and the original mail with one another, and stores the association (association information) in the mail association information DB 20 (step K50).

The mail processing unit 21 obtains the message body of the original mail, to which the mail processing unit 21 then inserts a sound replay phone number, thereby creating notification web data, and the web access processing unit 13 then presents a notification web page that is formed on the web data on the communication network 50 in an accessible manner (step K60), and then the processing ends.

Next, a description will be made hereinbelow of processing performed in the e-mail system 1g of the seventh embodiment when the sound data is replayed on the recipient's mobile phone 40.

The user of the mobile phone 40 sees the notification web page on the mobile phone 40, thereby being notified of the contents of the original mail, and then, the user selects the sound replay phone number shown on the web page, thereby making a phone call to the sound replay phone number with use of the PHONE TO function. Note that the processing performed by the sound-mail associating apparatus 10g is approximately the same as that of the fifth embodiment shown in FIG. 16.

In this manner, like effects and benefits to those of the fifth embodiment are realized by the e-mail system 1g according to the seventh embodiment of the present invention. In addition, the user of the mobile phone 40 can access the notification web page at his convenience to see the contents of the original mail, so that the convenience for users is increased.

In particular, even in a situation where a web page can be viewed while e-mail transmission/receipt is not available, it is still possible to see the contents of original mail.

(H) Eighth Embodiment:

Referring to FIG. 17, like the e-mail systems, 1e, 1f, and 1g, of the fifth, sixth, and seventh embodiments, respectively, an e-mail system 1h of the eighth embodiment of the present invention is for transmitting/receiving e-mail between the user of PC 70 and the user of mobile phone 40, and the e-mail system 1h has approximately the same construction as that of the e-mail system 1f of the sixth embodiment.

Instead of a notification e-mail message or a reply e-mail message, which is created by the mail processing unit 21 and transmitted to the destination address by the mail transmitting/receiving unit 11, the sound-mail associating apparatus 10g employs a web page (web mail) to show contents of the above e-mail messages thereon. Such a web page is offered by the web access processing unit 13.

More specifically, in the eighth embodiment, the web access processing unit 13 creates web data (notification web data) containing at least text information of the original mail received from the PC 70, to which web data the mobile phone 40 is accessible through the communication network 50.

In order to notify the mobile phone 40 of a sound replay phone number selected by the telephone number managing unit 18, a pointer (a URL or a link, or the like), prepared by the web access processing unit 13, for accessing a web page indicating a sound replay phone number (sound-replay phone number notification page) is inserted to the notification web data. In the following description, the web page created from this notification web data will be also called a notification web page.

In the above-described e-mail system 1h of the eighth embodiment, when the PC 70 sends-out an original mail message addressed to a recipient's mail address, the web access processing unit 13 creates notification web data about this original mail and then presents the data, as an accessible notification web page, on the communication network 50. The recipient sees the notification web page shown on the mobile phone 40 and listens to the original mail-associated sound data replayed on the mobile phone 40.

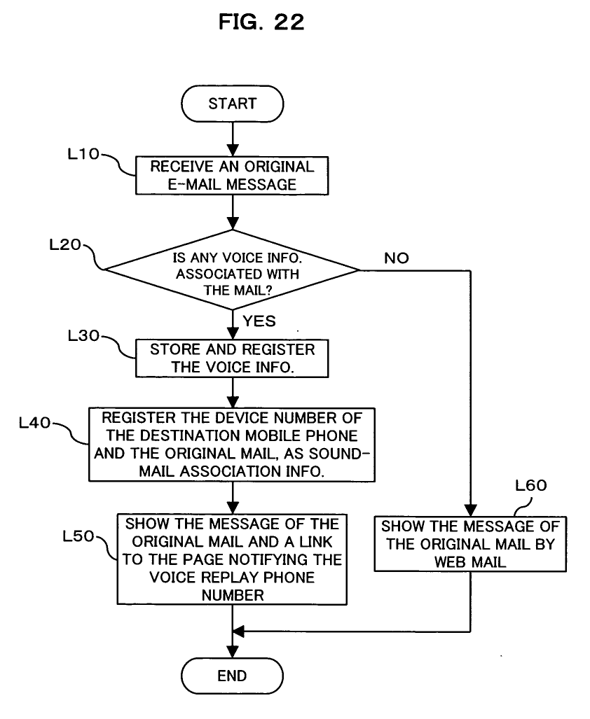

Referring to the flowchart (step L10 through step L60) of FIG. 22, a description will be made hereinbelow of processing performed in the e-mail system 1h according to the eighth embodiment of the present invention when web data on the original mail transmitted from the PC 70 is prepared.

The mail transmitting/receiving unit 11 of the sound-mail associating apparatus 10h receives an original mail message addressed to a recipient from the PC 70 (Step L10). The sound transmission/receipt detecting unit 17 detects whether or not the received original mail is associated with any sound data (step L20).

If the above detection result is negative (NO route of step L20), the web access processing unit creates web mail (notification web data) based on contents of the original mail, and then presents the web mail on the communication network 50 in an accessible manner (step L60), and then the processing ends.

On the other hand, if the detection result is positive (YES route of step L20), the sound information obtaining unit 30 obtains the sound data attached to the original mail, and then stores the sound data in the sound data DB 23 to be managed by the sound data managing unit 22 (step L30).

The sound-mail association managing unit 19 obtains the device number of the recipient's mobile phone 40 based on the mail address to which the original mail is addressed, and associates the obtained device number and the original mail with each other, and stores the association (association information) in the mail association information DB 20 (step L40).

The mail processing unit 21 obtains the message body of the original mail, to which the mail processing unit 21 then inserts a link tag for accessing the sound replay phone number notification page, thereby creating notification web data (web mail), and the web access processing unit 13 then presents the web data on the communication network 50 in an accessible manner (step L50), and then the processing ends.

Next, a description will be made hereinbelow of processing performed in the e-mail system 1h of the eighth embodiment when sound data is replayed on the mobile phone 40.

The user of the mobile phone 40 sees the notification web page on the mobile phone 40, thereby being notified of the contents of the original mail, and then, the user selects the link to the sound replay phone number notification page shown on the web page, thereby accessing the sound replay phone number. Note that the processing performed by the sound-mail associating apparatus 10h is approximately the same as that of the sixth embodiment shown in FIG. 20.

In this manner, like effects and benefits to those of the seventh embodiment are realized by the e-mail system 1h according to the eighth embodiment of the present invention.

(I) Ninth Embodiment:

According to the e-mail systems, 1b and 1d, of the second and the fourth embodiments, respectively, the telephone number managing unit 18 assigns a sound input phone number in response to the sound-input phone number notification page being accessed. The sound-mail association managing unit 19 associates the phone number (caller's number) of the mobile phone 40, the sound input phone number, and the original mail with one another, and then stores the association (association information) in the mail association information DB 20. The web access processing unit 13 shows the sound input phone number selected by the telephone number managing unit 18 on the sound-input phone number notification page. After that, the user selects the sound input phone number thus displayed on the sound-input phone number notification page, thereby making a phone call to the sound input phone number with the PHONE TO function of the mobile phone 40, which call is then received by the sound transmitting/receiving unit 14 (step D30 through D60 of FIG. 10). However, the invention should by no means be limited to these.

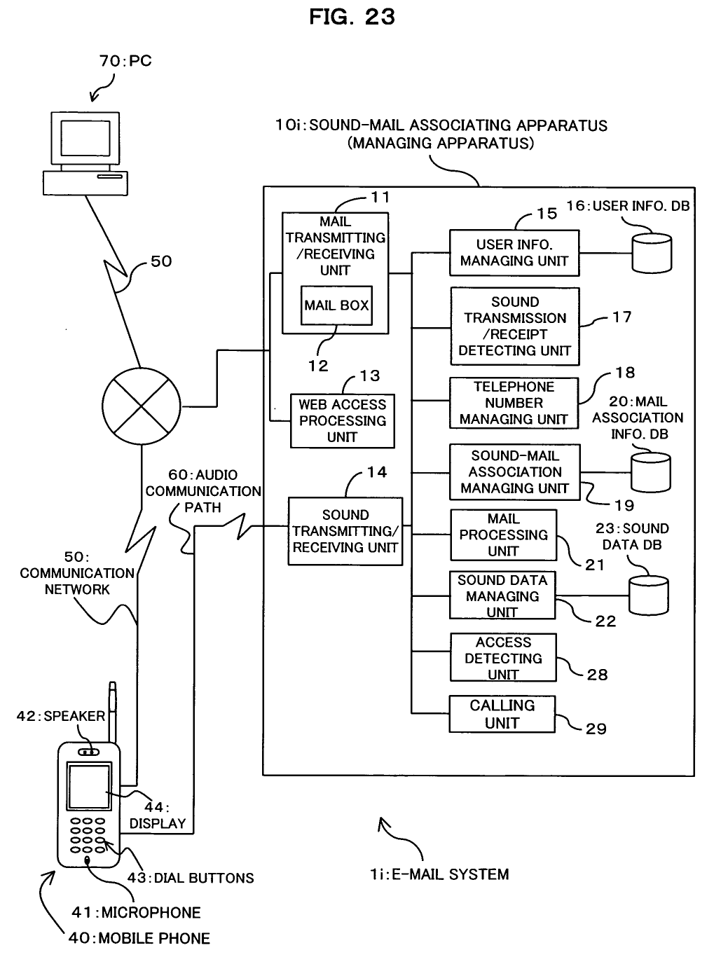

FIG. 23 shows a construction of an electronic mail (e-mail) system 1i in schematic form according to a ninth preferred embodiment of the present invention. As shown in FIG. 23, the sound-mail associating apparatus 10i of the e-mail system 1i of the ninth embodiment of FIG. 23 has an access detecting unit 28 and a calling unit 29 in place of the caller's number obtaining unit 25, the telephone number detecting unit 26, and the selecting unit 27 of the sound-mail associating apparatus 10b in FIG. 7.

The access detecting unit 28 detects whether or not access is made from the mobile phone 40 to a notification web page (notification web data) presented on the communication network 50 in an accessible manner. When such access is detected, the access detecting unit 28 notifies the calling unit 29. The access detecting unit 28 also obtains the device number of the mobile phone 40 that makes access to the notification web page.

The calling unit 29 calls the mobile phone 40 when the access detecting unit 28 detects such access made from the mobile phone 40 to the notification web page. More specifically, based on the device number obtained by the access detecting unit 28, the calling unit 29 recognizes the user of the mobile phone 40 through the user information managing unit 15 to obtain the phone number (caller's number) of the mobile phone 40. The calling unit 29 then calls the thus-obtained number.

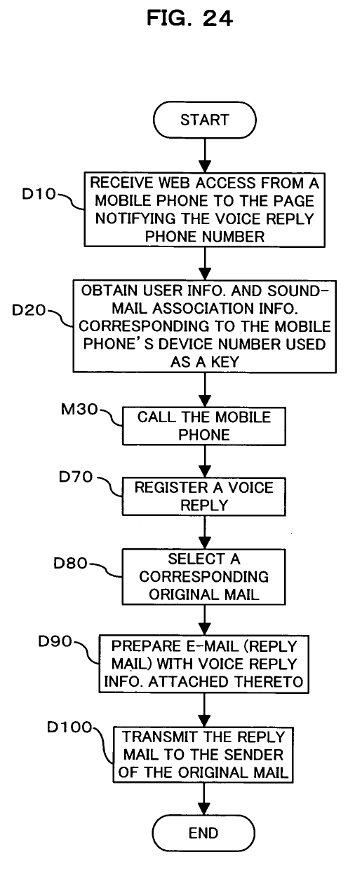

Referring to the flowchart (step D10, step D20, step M30, and step D70 through step D100) of FIG. 24, a description will be made hereinbelow of processing performed in the e-mail system 1i according to the ninth embodiment of the present invention when a voice reply is made on the mobile phone 40. In the following description, like reference numbers and characters designate similar parts or elements throughout several views of the present embodiment and the conventional art, so their detailed description is omitted here.

If the access detecting unit 28 detects that access is made on the mobile phone 40 to the notification web page, the calling unit 29 recognizes the user of the mobile phone 40, through the user information managing unit 15, based on the device number obtained by the access detecting unit 28 to obtain the phone number (caller's number) of the mobile phone 40. The calling unit 29 then calls the thus-obtained number (M30).

In this manner, with the e-mail system 1i according to the ninth embodiment of the present invention, since the user does not need to call the sound input phone number, the user's convenience is increased. Additionally, since only a small number of phone numbers need to be prepared as sound input phone numbers, cost performance of the system is improved.

(J) Tenth Embodiment:

According to the e-mail systems, 1f and 1h, of the sixth and the eighth embodiments, respectively, the telephone number managing unit 18 assigns the original mail a sound replay phone number in response to access made by a user to the sound-replay phone number notification page. The sound-mail association managing unit 19 associates the phone number (caller's number) of the mobile phone 40, the sound replay phone number, and the original mail with one another, and then stores the association (association information) in the mail association information DB 20. The web access processing unit 13 shows the sound replay phone number selected by the telephone number managing unit 18 on the sound-replay phone number notification page. After that, the user selects the sound replay phone number thus displayed on the sound-replay phone number notification page, thereby making a phone call to the sound replay phone number with the PHONE TO function of the mobile phone 40, which call is then received by the sound transmitting/receiving unit 14 (step J30 through J60 of FIG. 20). However, the invention should by no means be limited to these.

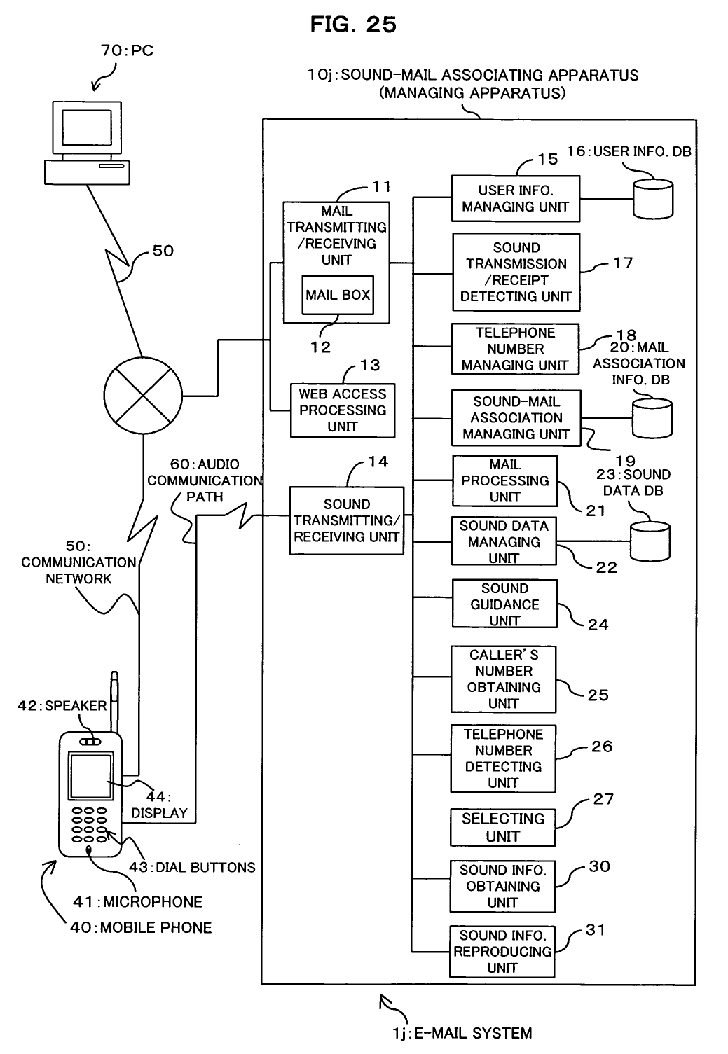

FIG. 25 shows a construction of an electronic mail (e-mail) system 1i in schematic form according to a 10th preferred embodiment of the present invention. As shown in FIG. 25, the sound-mail associating apparatus 10i of the e-mail system 1i of the 10th embodiment of FIG. 25 has an access detecting unit 28 and a calling unit 29 in place of the caller's number obtaining unit 25, the telephone number detecting unit 26, and the selecting unit 27, of the sound-mail associating apparatus 10f in FIG. 17. Like reference numbers and characters designate similar parts or elements throughout several views of the present embodiment and the conventional art, so their detailed description is omitted here.

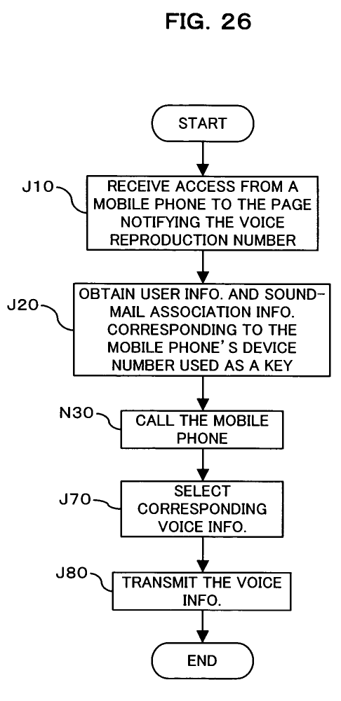

Referring to the flowchart (step J10, step J20, step N30, step J70, and step J80) of FIG. 26, a description will be made hereinbelow of processing performed in the e-mail system 1j according to the 10th embodiment of the present invention when a voice reply is made on the mobile phone 40. In the following description, like reference numbers and characters designate the same or approximately the same steps throughout the several embodiments, so their detailed description is omitted here.

If the access detecting unit 28 detects that access has been made on the mobile phone 40 to the sound-relay phone number notification page, the calling unit 29 recognizes the user of the mobile phone 40, through the user information managing unit 15, based on the device number obtained by the access detecting unit 28 to obtain the phone number (caller's number) of the mobile phone 40. The calling unit 29 then calls the thus-obtained number (step N30).

In this manner, with the e-mail system 1j according to the 10th embodiment of the present invention, since the user does not need to call the sound replay phone number, the user's convenience is increased. Additionally, since only a small number of phone numbers are required to be prepared as sound replay phone numbers, cost performance of the system is improved.

(K) Eleventh Embodiment:

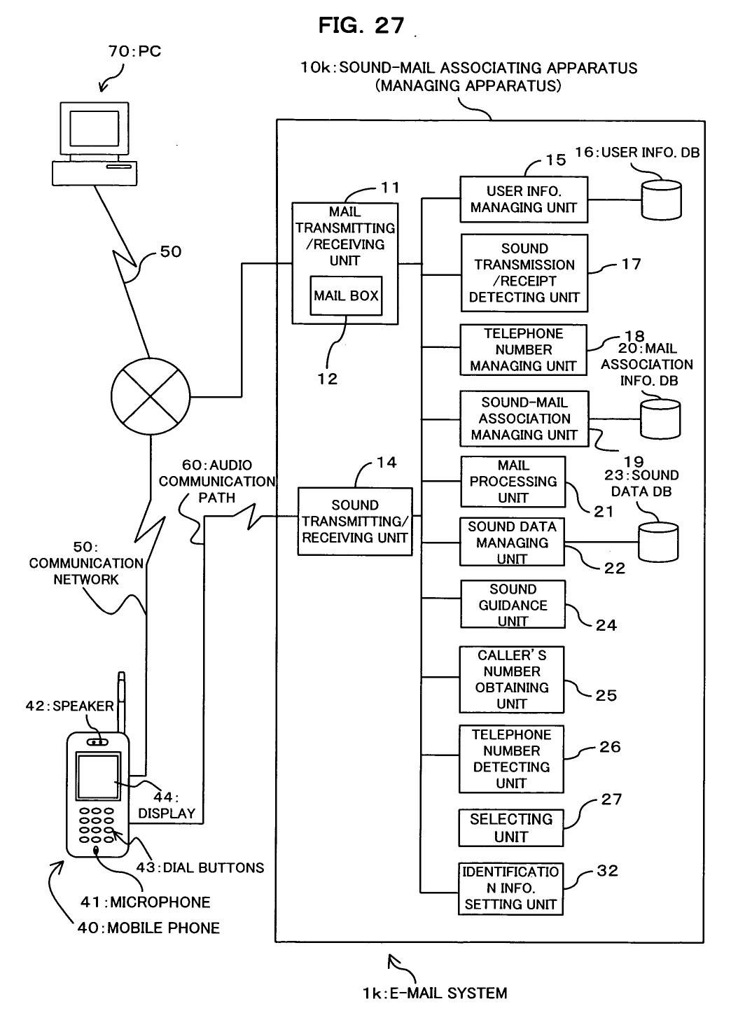

FIG. 27 shows a construction of an electronic mail (e-mail) system 1k in schematic form according to an 11th preferred embodiment of the present invention. As shown in FIG. 27, the e-mail system 1k has a sound-mail associating apparatus 10k in place of the sound-mail associating apparatus 10a of the e-mail system 1a of the first embodiment.

The sound-mail associating apparatus 10k has the same construction as that of the sound-mail associating apparatus 10a with an identification information setting unit 32 additionally provided thereto.

If there are two or more original mail (e-mail) messages, the identification information setting unit 32 provides each of the original messages with an individual original mail ID (identification information).

Such original mail IDs are identifiers formed by varying combinations of alphanumeric characters and symbols, and every original mail message is provided with its unique ID.

Every time the mail transmitting/receiving unit 11 receives an original mail message, the identification information setting unit 32 assigns an original mail ID to the message.

When creating notification e-mail or notification web data, the mail processing unit 21 inserts such an original mail ID assigned by the identification information setting unit 32, together with a sound input phone number selected by the telephone number managing unit 18, into the notification e-mail.

The sound-mail association managing unit 19 stores and manages the original mail ID in the mail association information DB 20, in association with the original mail.

Further, in the sound-mail associating apparatus 10k of the 11th embodiment, when a voice reply is made on the mobile phone 40 to the original mail, the sound-mail association managing unit 19 refers to the mail association information DB 20 to recognize how many original mail messages are associated with the sound input phone number having been used or the caller's number. If there are two or more of such original mail messages, the sound guidance unit 24 offers guidance by voice to instruct the user to input an original mail ID to identify the original mail message he wants to reply to.

Following this guidance, the user of the mobile phone 40 inputs the original mail ID through dial buttons (ID information inputting unit) 43 of the mobile phone 40.

Here, in the 11th embodiment, such a phone number the telephone number managing unit 18 sets as a sound input phone number, is not unique to an individual original mail message but is common to two or more original messages.

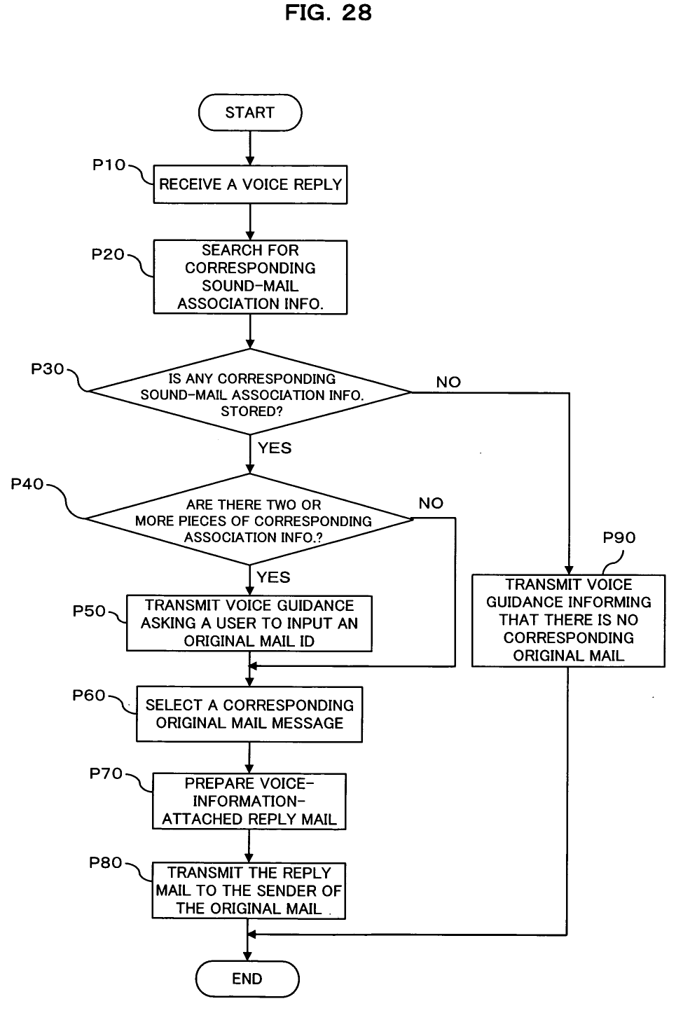

Referring to the flowchart (step P10 through step P90) of FIG. 28, a description will be made hereinbelow of processing performed in the e-mail system 1k according to the 11th embodiment of the present invention when a voice reply is made on the mobile phone 40.

Upon receipt of a notification e-mail message notifying about an original mail message addressed to him, the recipient selects the sound input phone number shown in the message body of the notification mail, thereby making a phone call to the sound input phone number with use of the PHONE TO function, which call is then received by the sound-mail associating apparatus 10k (step P10).

The sound-mail association managing unit 19 searches the mail association information DB 20 for an original mail message that is associated with such phone numbers (sound input phone number or caller's number) (step P20), and then detects whether or not there is any such associated original mail message registered in the mail association information DB 20 (step P30). If the detection result is negative, (NO route of step P30), the sound guidance unit 24 offers a message that there is no such original mail message (step P90), and the processing ends.

On the other hand, if the detection result is positive (YES route of step P30), the sound-mail association managing unit 19 then detects whether or not there are two or more of such associated original mail messages stored in the mail association information DB 20 (step P40). If the detection result is positive (YES route of step P40), the sound guidance unit 24 offers guidance by voice for instructing the user to input an original mail ID to identify an original mail message to be replied to (step P50).

After that, the user inputs the original mail ID, following the guidance given by the sound guidance unit 24, thereby selecting the original mail to be replied to (step P60), and the mail processing unit 21 creates a reply e-mail message to the thus-selected original mail (step P70). Here, if there is only one of such associated original mail messages (NO route of step P40), the processing proceeds to step P70.

The mail transmitting/receiving unit 11 sends out the thus-created reply e-mail message to the sender of the original mail (step P80), and the processing ends.

In this manner, in the e-mail system 1k of the 11th embodiment, the identification information setting unit 32 assigns every original mail message an individual original mail ID for identification. When a voice reply is made on the mobile phone 40 to the original mail, such an ID is input to identify the original mail to be replied to, so that the original mail can be easily associated with its reply.

In addition, with this feature, since the necessity for assigning different sound input phone numbers, one to each original mail message, is eliminated, a reduced number of phone numbers will be required by the e-mail system 1k, thus improving cost performance of the system. Moreover, since the e-mail system 1k can be concurrently used by a great number of users, the convenience of users will also be improved.

It is to be noted that, like the e-mail system 1k of the 11th embodiment, the foregoing e-mail system 1c of the third embodiment can also have an identification information setting unit 32 additionally provided for the construction of the sound-mail associating apparatus 10c, and the mail processing unit 21 and the web access processing unit 13 can show the original mail ID, along with the sound input phone number, in the notification web data, thereby making it possible to realize similar effects and benefits to those of the 11th embodiment.

(L) Twelfth Embodiment:

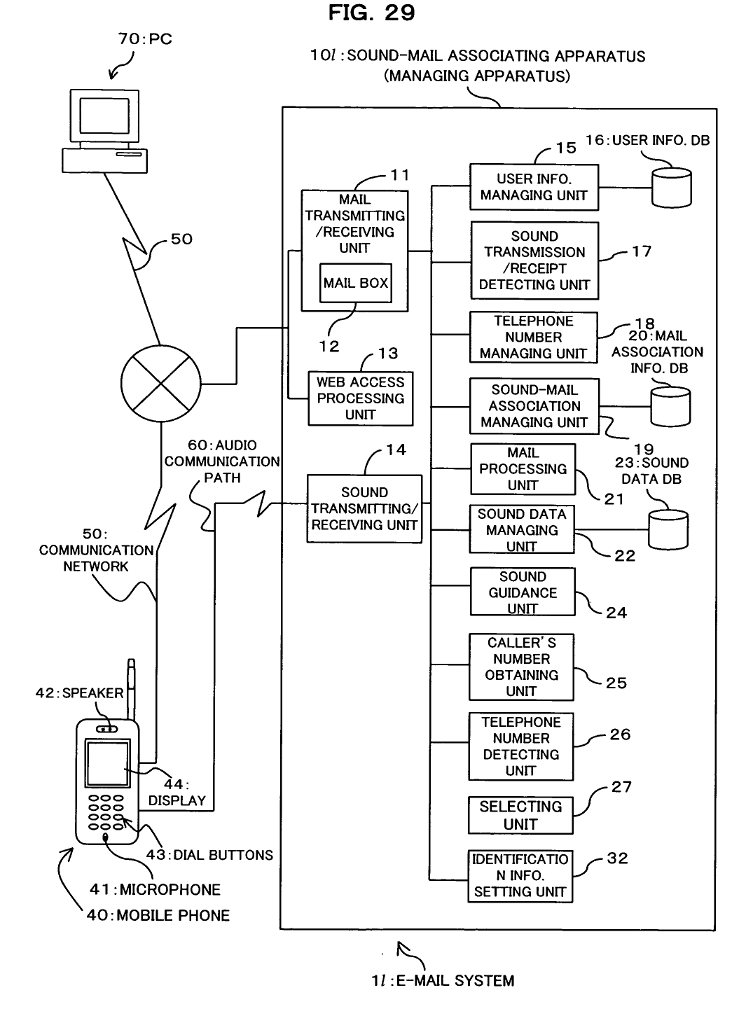

FIG. 29 shows a construction of an electronic mail (e-mail) system, in schematic form, according to a 12th preferred embodiment of the present invention. As shown in FIG. 29, an e-mail system 1l has a sound-mail associating apparatus 10l in place of the sound-mail associating apparatus, 10b and 10d, of the e-mail systems, 1b and 1d (see FIG. 13), of the second and the third embodiments, respectively. In the following description, like reference numbers and characters designate similar parts or elements throughout several views of the present embodiment and the conventional art, so their detailed description is omitted here.

The sound-mail associating apparatus 10l has an identification information setting unit 32 additionally provided for the construction of the sound-mail associating apparatus, 10b and 10d, of the second and the fourth embodiments, respectively.

The mail processing unit 21 and the web access processing unit 13 show an original mail ID, having been set by the identification information setting unit 32, on a web page (sound-input phone number notification page) that shows a sound input phone number thereon. If there are two or more original mail messages that are associated with phone numbers (sound input phone number or caller's number) used by the mobile phone 40, the web access processing unit 13 offers guidance to instruct the user to input an original mail ID for identifying an original mail message to be replied to.

According to the guidance given by the web access processing unit 13, the user of the mobile phone 40 inputs an original mail ID through dial buttons (identification information inputting unit) 43 of the mobile phone 40.

At such selection of an original mail ID, the ID can be input directly, or alternatively, an arbitrary one can be chosen from a list of original mail messages or their contents shown in combination.

If it is found, after searching by the sound-mail association managing unit 19, that there is no original mail associated with the sound input phone number or the caller's number, the web access processing unit 13 shows a message indicating to that effect on a web page.

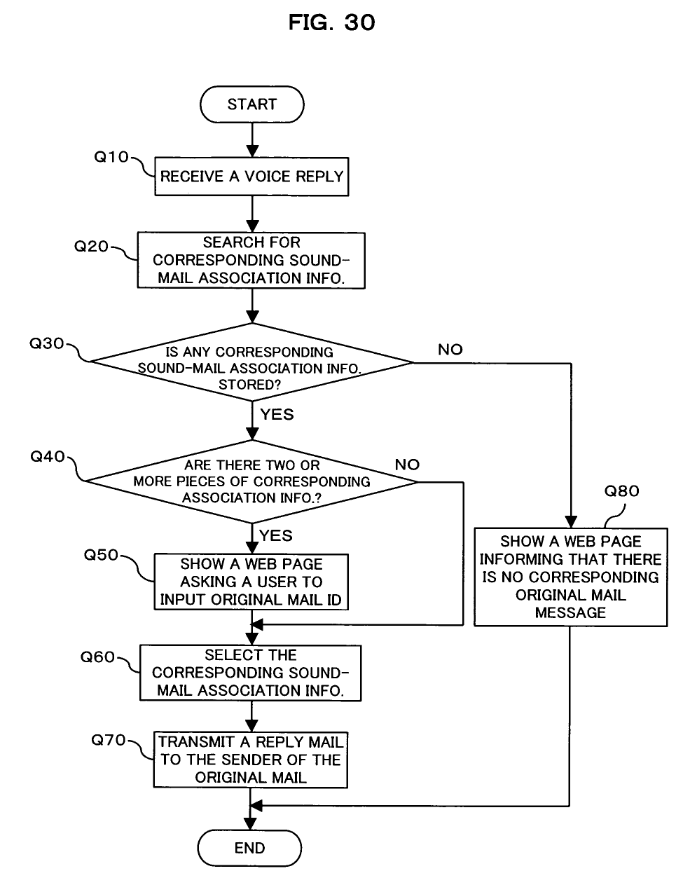

Referring to the flowchart (step Q10 through step Q80) of FIG. 30, a description will be made hereinbelow of processing performed in the e-mail system 1l according to the 12th embodiment of the present invention when a voice reply is made on the mobile phone 40.

Upon receipt of the original mail, the user of the mobile phone 40 selects a sound input phone number inserted into its message body, thereby making a call to the number with the PHONE TO function. The sound-mail associating apparatus 10l receives the telephone call made from the mobile phone 40 (step Q10).

The sound-mail association managing unit 19 searches the mail association information DB 20 for an original mail message that is associated with the sound input phone number or the caller's number (step Q20), and then detects whether or not there is any such associated original mail message registered in the mail association information DB 20 (step Q30). If the detection result is negative, (NO route of step Q30), the web access processing unit 13 shows a message informing to that effect on a web page (step Q80), and the processing ends.

On the other hand, if the detection result is positive (YES route of step Q30), the sound-mail association managing unit 19 then detects whether or not there are two or more of such associated original mail messages stored in the mail association information DB 20 (step Q40). If the detection result is positive (YES route of step Q40), the web access processing unit 13 shows a web page through which the user inputs an original mail ID for identifying the original mail to be replied to (step Q50). In this manner, the original mail message to be replied to is selected by inputting the original mail ID through the web page.

After that, the sound-mail association managing unit 19 obtains information about the selected original mail message from the mail association information DB 20 (step Q60), and the mail processing unit 21 creates a reply e-mail message to the original mail, which reply e-mail is then sent out from the mail transmitting/receiving unit 11 to the sender of the original mail (step Q70), and the processing ends.

Here, if there is only one of such associated original mail messages (NO route of step Q40), the processing proceeds to step Q60.

In this manner, with the e-mail system 1l according to the 12th embodiment of the present invention, like effects and benefits to those of the 11th embodiment are realized.

(M) Thirteenth Embodiment:

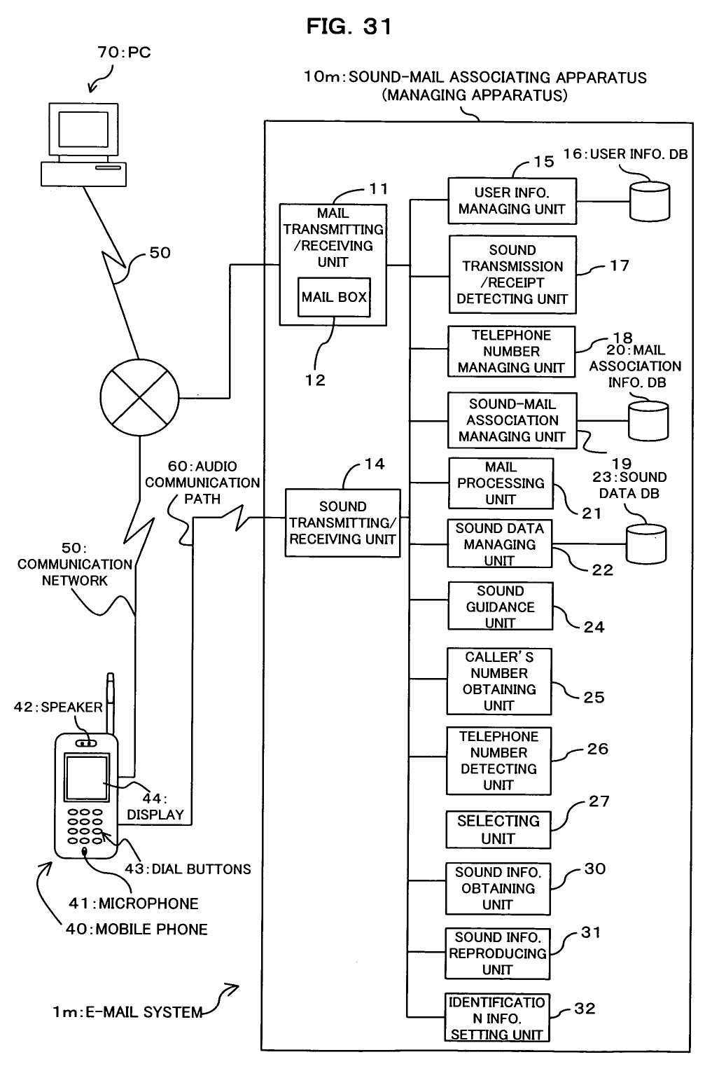

FIG. 31 shows a construction of an electronic mail (e-mail) system, in schematic form, according to a 13th preferred embodiment of the present invention. As shown in FIG. 30, an e-mail system 1m has a sound-mail associating apparatus 10m in place of the sound-mail associating apparatus 10e of the e-mail systems 1e according to the fifth embodiment.

The sound-mail associating apparatus 10m has an identification information setting unit 32 additionally provided for the construction of the sound-mail associating apparatus 10e of the fifth embodiment. In the following description, like reference numbers and characters designate similar parts or elements throughout several views of the present embodiment and the conventional art, so their detailed description is omitted here.

In the sound-mail associating apparatus 10m of the 13th embodiment, when sound data associated with an original mail message is replayed on the mobile phone 40, the sound-mail association managing unit 19 refers to the mail association information DB 20 to recognize how many original mail messages are associated with the phone number (sound input phone number or caller's number) the mobile phone 40 has used. If there are two or more of such original mail messages, the sound guidance unit 24 offers guidance by voice sound to instruct the user to input an original mail ID to identify the original mail message to be replayed (reproduced).

Here, like the 11th embodiment, the phone number the telephone number managing unit 18 sets as a sound input phone number, is not unique to an individual original mail message but is common to two or more original messages.

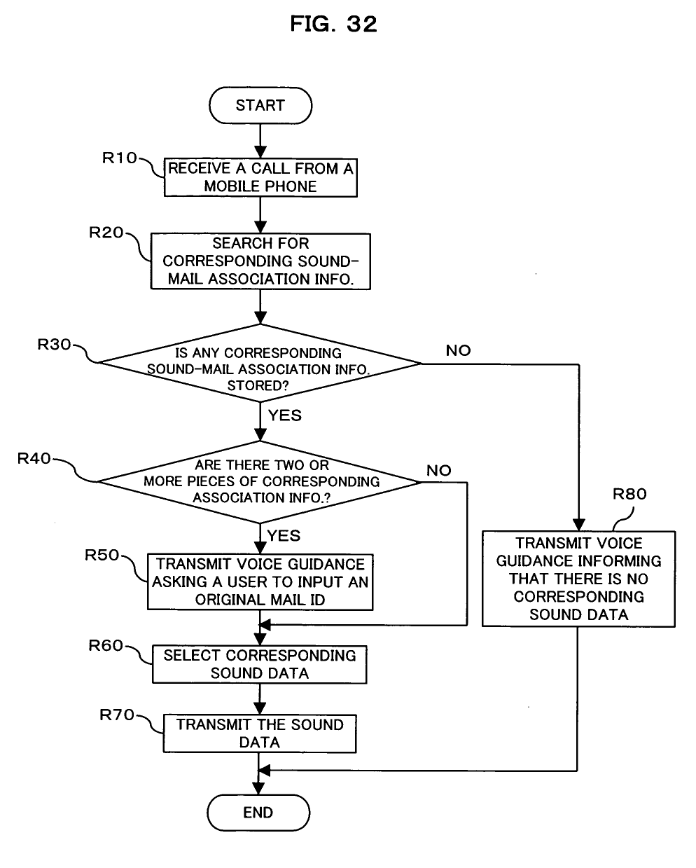

Referring to the flowchart (step R10 through step R80) of FIG. 32, a description will be made hereinbelow of processing performed in the e-mail system 1m according to the 13th embodiment of the present invention, when sound data is replayed on the mobile phone 40.

Upon receipt of notification e-mail on the mobile phone 40, thereby being notified about an original mail message addressed to him, the user of the mobile phone 40 selects a sound replay phone number inserted in the message body of the notification e-mail, thereby making a call to the number with use of the PHONE TO function. The sound-mail associating apparatus 10m receives the telephone call made from the mobile phone 40 (step R10).

The sound-mail association managing unit 19 searches the mail association information DB 20 for an original mail message that is associated with the phone numbers (sound replay phone number or caller's number) having been used by mobile phone 40 (step R20), and then detects whether or not there is any such associated original mail message registered in the mail association information DB 20 (step R30). If the detection result is negative, (NO route of step R30), the sound guidance unit 24 offers a message that there is no such original mail message (step R80), and the processing ends.

On the other hand, if the detection result is positive (YES route of step R30), the sound-mail association managing unit 19 then detects whether or not there are two or more of such associated original mail messages stored in the mail association information DB 20 (step R40). If the detection result is positive (YES route of step R40), the sound guidance unit 24 offers guidance by voice for instructing the user to input an original mail ID to identify an original mail message to be replayed (step R50).

After that, the user inputs the original mail ID, following the guidance given by the sound guidance unit 24, thereby selecting the original mail to be replayed (step R60), and the sound information reproducing unit 31 obtains sound data associated with the thus-selected original mail from the sound data DB 23 so as to reproduce the sound data. The thus-reproduced sound data is then sent out from the sound transmitting/receiving unit 14 to the mobile phone 40 through the audio communication path 60 (step R70), and the processing ends.

In this manner, in the e-mail system 1m of the 13th embodiment, the identification information setting unit 32 assigns every original mail message an individual original mail ID for identification. When sound data is replayed on the mobile phone 40, a user inputs such an ID to identify the original mail associated with the sound data that is to be replayed, thereby easily selecting the original mail.

In addition, with this feature, since the necessity for assigning different sound input phone numbers, one to each original mail message, is eliminated, a reduced number of phone numbers will be required by the e-mail system 1m, thus improving cost performance of the system.

It is to be noted that, like this e-mail system 1m of the 13th embodiment, the foregoing e-mail system 1g of the seventh embodiment can also have an identification information setting unit 32 additionally provided to the construction of the sound-mail associating apparatus 10g, and the mail processing unit 21 and the web access processing unit 13 can show the original mail ID, along with the sound replay phone number, in the notification web data, thereby making it possible to realize similar effects and benefits to those of the 13th embodiment.

(N) Fourteenth Embodiment:

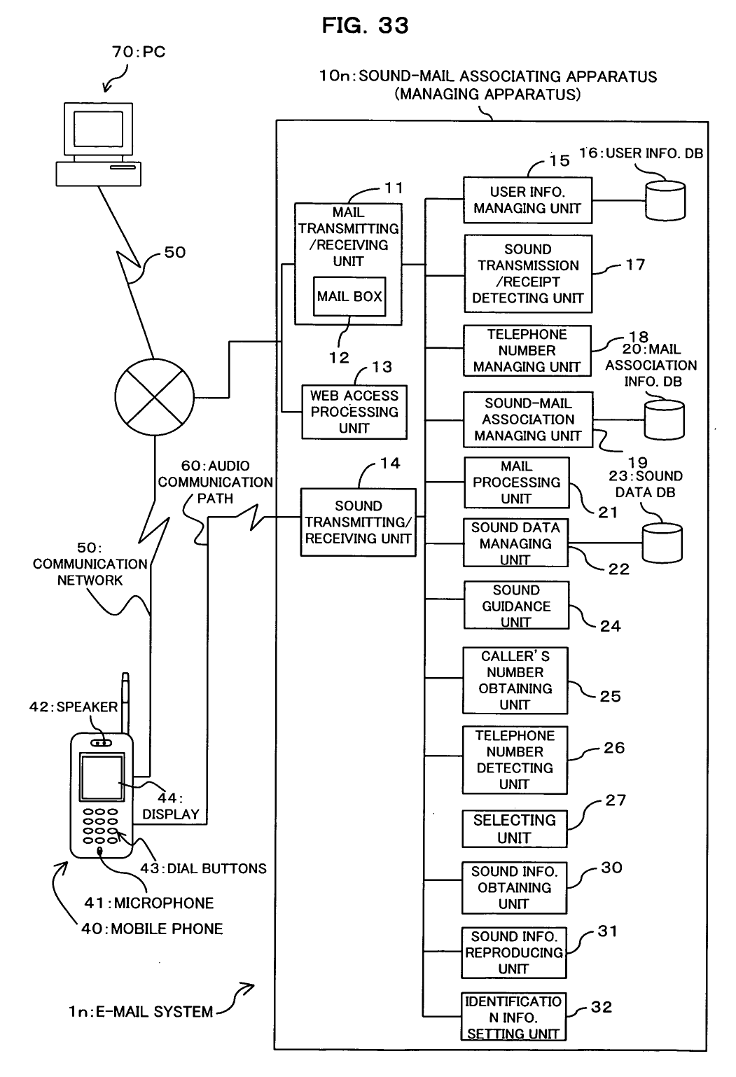

FIG. 33 shows a construction of an electronic mail (e-mail) system 1n in schematic form according to a 14th preferred embodiment of the present invention. As shown in FIG. 33, the e-mail system 1n has a sound-mail associating apparatus 10n in place of the sound-mail associating apparatus 10j of the e-mail system 1j of the 10th embodiment.

The sound-mail associating apparatus 10n has the same construction as that of the sound-mail associating apparatus 10j with an identification information setting unit 32 additionally provided thereto. In the following description, like reference numbers and characters designate similar parts or elements throughout several views of the present embodiment and the conventional art, so their detailed description is omitted here.

In the sound-mail associating apparatus 10n of the 14th embodiment, the mail processing unit 21 and the web access processing unit 13 show an original mail ID, assigned by the identification information setting unit 32, on a web page (sound-replay phone number notification page) indicating a sound replay phone number thereon.

Further, in the sound-mail associating apparatus 10n of the 14th embodiment, when sound data associated with an original mail message is replayed on the mobile phone 40, the sound-mail association managing unit 19 refers to the mail association information DB 20 to recognize how many original mail messages are associated with a phone number (sound replay phone number or caller's number) the mobile phone 40 has used.

Then, if there are two or more of such original mail messages, the web access processing unit 13 instructs the user to input an original mail ID to identify the original mail message associated with sound data that is to be replayed.

At such inputting of an original mail ID, the ID can be input directly, or alternatively, an arbitrary original mail can be chosen from a list of original mail messages or their contents shown in combination.

If it is found, after the sound-mail association managing unit 19 searches the mail association information DB 20, that there is no original mail associated with the sound replay phone number or the caller's number, the web access processing unit 13 shows a message indicating to that effect on a web page.

Here, like the 11th embodiment, the phone number the telephone number managing unit 18 sets as a sound input phone number, is not unique to an individual original mail message but is common to two or more original messages.

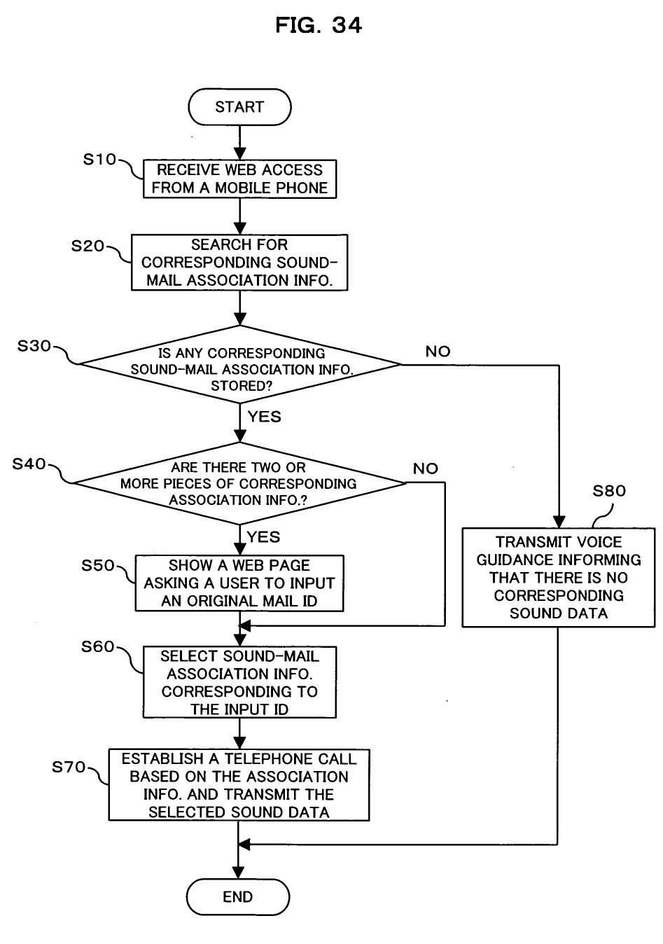

Referring to the flowchart (step S10 through step S80) of FIG. 34, a description will be made hereinbelow of processing performed in the e-mail system 1n according to the 14th embodiment of the present invention, when sound data is replayed on the mobile phone 40.

Upon receipt of notification e-mail on the mobile phone 40, thereby being notified about an original mail message addressed to him, the user of the mobile phone 40 selects a pointer, inserted in the message body of the notification e-mail, for accessing a sound replay web page, or selects a pointer, inserted in notification web data, for accessing the sound replay web page, thereby accessing the sound replay web page with use of the PHONE TO function. The access detecting unit 28 receives the web access made from the mobile phone 40 (step S10).

The access detecting unit 28 obtains the device number of the mobile phone 40 which has accessed the sound replay web page, and then searches the mail association information DB 20 for an original mail message associated with the device number (step S20), and then detects whether or not there is any such associated original mail message registered in the mail association information DB 20 (step S30). If the detection result is negative, (NO route of step S30), the web access processing unit 13 shows a message informing that there is no associated original mail (or sound data) on a web page (step S80), and the processing ends.

On the other hand, if the detection result is positive (YES route of step S30), the sound-mail association managing unit 19 then detects whether or not there are two or more of such associated original mail messages stored in the mail association information DB 20 (step S40). If the detection result is positive (YES route of step S40), the web access processing unit 13 shows a web page through which the user inputs an original mail ID for identifying the original mail to be replayed (step S50). In this manner, the original mail message to be replayed is selected by inputting the original mail ID through the web page.

Here, on the basis of the device number obtained by the access detecting unit 28, the calling unit 29 recognizes the user of the mobile phone 40 through the user information managing unit 15, and obtains the phone number (caller's number) of the mobile phone 40. The calling unit 29 then calls the thus-obtained number to establish a telephone communication.

The sound information reproducing unit 31 obtains sound data associated with the thus-selected original mail from the sound data DB 23 so as to reproduce the sound data. The thus-reproduced sound data is then sent out from the sound transmitting/receiving unit 14 to the mobile phone 40 through the audio communication path 60 (step S70), and the processing ends.

Here, if there is only one of such associated original mail messages (NO route of step S40), the processing proceeds to step S60.

In this manner, like effects and benefits to those of the 14th embodiment are realized by the e-mail system in according to the 13th embodiment of the present invention.

(O) Others:

In the foregoing embodiments, the CPU (Central Processing Unit) of the information processing apparatus executes programs stored in a computer-readable recording medium (for example, a memory, magnetic storage apparatus, floppy disc, memory card, magneto-optical storage device, CD-ROM, CD-R, CD-RW, DVD, DVD-R, DVD-RW, and so on), thereby serving as the aforementioned mail transmitting/receiving unit 11, web access processing unit 13, sound-mail associating apparatus 10, sound transmitting/receiving unit 14, user information managing unit 15, sound transmission/receipt detecting unit 17, telephone number managing unit 18, sound-mail association managing unit 19, mail processing unit 21, sound data managing unit 22, sound guidance unit 24, caller's number obtaining unit 25, telephone number detecting unit 26, selecting unit 27, sound information obtaining unit 30, sound information reproducing unit 31, and identification information setting unit 32.

The present invention should by no means be limited to the above-illustrated embodiment, and various changes or modifications may be suggested without departing from the gist of the invention.

For instance, although the e-mail system, 1a, 1b, 1c, 1d, 1e, 1f, 1g, 1h, 1i, 1j, 1k, 1l, 1m, 1n, as shown in FIGS. 1, 7, 13, 17, 23, 25, 27, 29, 31, 33, includes a single PC 70 and a single mobile phone 40, the present invention should not be limited to this, and two or more PCs or two or more mobile phones can be applicable.

Further, in the foregoing embodiments, the e-mail system 1 includes a PC (first information terminal) and a mobile phone (second information terminal) 40. The present invention should not be limited to this, and another mobile phone 40 can be employed instead of a PC 70.

Still further, in the above-described 11th through 14th embodiments, original mail IDs are given, one to each of the original mail messages, for identifying sound data associated with such each original mail message. The present invention should not be limited to this, and for example, identification information (sound data ID) can be provided to each piece of sound data.

Furthermore, as in the case of the ninth embodiment, the aforementioned 11th and 12th embodiments can be provided with an access detecting unit 28 and calling unit 29, instead of the caller's number obtaining unit 25, telephone number detecting unit 26, and selecting unit 27. If the access detecting unit 28 detects access made from the mobile phone 40 to a sound-input phone number notification page, the calling unit 29 calls the mobile phone 40.

The disclosure of the embodiments of the present invention will make it possible for persons skilled in the art to manufacture the present system.

### INDUSTRIAL APPLICABILITY

As described above, an e-mail system, an e-mail transmission method, an information processing apparatus, an e-mail managing program, and a computer-readable recording medium storing the e-mail managing program thereon, according to the present invention are suitable for use in transmitting/receiving e-mail messages with an e-mail system, such as that for mobile phones, in which system sound information and an e-mail message (text information) are transmitted/received in different methods. The invention is particularly effective in handling sound information.

1. An electronic mail (e-mail) system that has: a first information terminal (70) for transmitting and receiving sound information and text information; a second information terminal (40) for transmitting and receiving sound information and text information in different ways; and a managing apparatus (10a, 10b, 10c, 10d, 10e, 10f, 10g, 10h, 10i, 10j, 10k, 10l, 10m, 10n), communicably interconnected between said first information terminal (70) and said second information terminal (40), for managing an e-mail message that includes at least text information to be transmitted and received between said first information terminal (70) and said second information terminal (40),
said managing apparatus (10a, 10b, 10c, 10d, 10e, 10f, 10g, 10h, 10i, 10j, 10k, 10l, 10m, 10n) comprising:
a text information notifying unit (21) for notifying said second information terminal (40) of the text information included in the e-mail message;
a sound information storing unit (23) adapted to store sound information related to the e-mail message; and
a managing unit (19) for managing association between the e-mail message and the sound information related to the e-mail message.

2. An e-mail system as set forth in claim 1, wherein said managing apparatus (10a, 10b, 10c, 10d, 10e, 10f, 10g, 10h, 10i, 10j, 10k, 10l, 10m, 10n) further comprising:
a telephone number selecting unit (18) for selecting a telephone number for use in handling the sound information related to the e-mail message transmitted from said first information terminal (70) to said second information terminal (40);
a telephone number notifying unit (21) for notifying said second information terminal (40) of the telephone number selected by said telephone number selecting unit (18); and
a managing unit (19) for managing association among the e-mail message, the telephone number, and the sound information related to the e-mail message.

3. An e-mail system as set forth in claim 2, further comprising:
a caller number obtaining unit (25) for obtaining a telephone number of said second information terminal (40) from which a telephone call is made to the telephone number selected by said telephone number selecting unit (18);
a telephone number detecting unit (26) for detecting whether or not a combination of the telephone number that is selected by said telephone number selecting unit (18) and the telephone number that is obtained by said caller number obtaining unit (25) matches a pre-determined combination; and
a selecting unit (27) for selecting, if the detection result by said telephone number detecting unit (26) is positive, the e-mail message as the one to which a reply message is to be made.

4. An e-mail system as set forth in claim 1,
wherein said second information terminal (40) includes a reply sound input unit (41) for inputting sound information, as a reply to the e-mail message, through an audio communication line specified by the telephone number,
wherein, of said managing apparatus (10a, 10b, 10c, 10d, 10i, 10k, 10l), said sound information storing unit (23) stores such sound information input from said reply sound input unit (41) as sound information related to the e-mail message, and
wherein said managing apparatus (10a, 10b, 10c, 10d, 10i, 10k, 10l) further comprises a reply information notifying unit (21) for notifying said first information terminal (70) of reply information that a reply in sound information form has been obtained from said second information terminal (40), based on the association managed by said managing unit (19).

5. An e-mail system as set forth in claim 4, wherein said reply information is a reply e-mail message.

6. An e-mail system as set forth in claim 5, wherein said reply e-mail message has the sound information attached thereto, which has been received from said second information terminal (40) and then stored in said sound information storing unit (23).

7. An e-mail system as set forth in claim 5, wherein said reply e-mail message has a pointer for use in accessing a section of said sound information storing unit (23) in which section said sound information is stored.

8. An e-mail system as set forth in claim 4, wherein said reply information is web data placed on the Internet.

9. An e-mail system as set forth in claim 4, wherein, of said managing apparatus (10a, 10b, 10c, 10d, 10i, 10k, 10l),
said text information notifying unit (21) prepares a notification e-mail message that contains the text information to be notified to said second information terminal (40);
said telephone number selecting unit (18) selects a sound input phone number for use in inputting sound from said second information terminal (40); and
said telephone number notifying unit (21) adds information about the sound input phone number, which is selected by said telephone number selecting unit (18), to the notification e-mail message, which is prepared by said text information notifying unit (21).

10. An e-mail system as set forth in claim 4, wherein, of said managing apparatus (10a, 10b, 10c, 10d, 10i, 10k, 10l),
said text information notifying unit (21) prepares notification web data to which said second information terminal (40) is accessible, said notification web data including at least the text information received from said first information terminal (70);
said telephone number selecting unit (18) selects a sound input phone number for use in inputting sound from said second information terminal (40); and
said telephone number notifying unit (21) adds information about the sound input phone number, which is selected by said telephone number selecting unit (18), to the notification web data, which is prepared by said text information notifying unit (21).

11. An e-mail system as set forth in claim 10, further comprising an access detecting unit (28) for detecting whether or not access has been made by said second information terminal (40) to the notification web data,
if the detection result by said access detecting unit (28) is positive, said telephone number selecting unit (18) selecting said sound input phone number.

12. An e-mail system as set forth in claim 9, wherein said information about the sound input phone number is said sound input phone number itself.

13. An e-mail system as set forth in claim 9, wherein said information about the sound input phone number is an address of a web page indicating the sound input phone number thereon or a pointer for use in accessing the web page.

14. An e-mail system as set forth in claim 1,
wherein, of said managing apparatus (10a, 10b, 10c, 10d, 10i, 10k, 10l), said text information notifying unit (21) prepares notification web data to which said second information terminal (40) is accessible, said notification web data including at least the text information received from said first information terminal (70), and
wherein said managing apparatus (10a, 10b, 10c, 10d, 10i, 10k, 10l) includes:
an access detecting unit (28) for detecting whether or not access has been made by said second information terminal (40) to the notification web data; and
a calling unit (29) for calling said second information terminal (40), if the detection result by said access detecting unit (28) is positive.

15. An e-mail system as set forth in claim 14,
wherein said second information terminal (40) includes a reply sound input unit (41) for inputting sound information, as a reply to the e-mail message, through an audio communication line specified by the telephone number,
wherein, of said managing apparatus (10a, 10b, 10c, 10d, 10i, 10k, 10l), said sound information storing unit (23) stores such sound information input from said reply sound input unit (41) as sound information related to the e-mail message, and
wherein said managing apparatus (10a, 10b, 10c, 10d, 10i, 10k, 10l) further comprises a reply information notifying unit (21) for notifying said first information terminal (70) of reply information that a reply in sound information form has been obtained from said second information terminal (40), based on the association managed by said managing unit (19).

16. An e-mail system as set forth in claim 15, wherein said reply information is a reply e-mail message.

17. An e-mail system as set forth in claim 16, wherein said reply e-mail message has the sound information attached thereto, which has been received from said second information terminal (40) and then stored in said sound information storing unit (23).

18. An e-mail system as set forth in claim 16, wherein said reply e-mail message has a pointer for use in accessing a section of said sound information storing unit (23) in which section said sound information is stored.

19. An e-mail system as set forth in claim 15, wherein said reply information is web data placed on the Internet.

20. An e-mail system as set forth in claim 2, wherein, if the e-mail message, transmitted from said first information terminal (70) to said second information terminal (40), has information added thereto about the sound information, said managing apparatus (10a, 10b, 10c, 10d, 10i, 10k, 10l) further comprises:
a sound information obtaining unit (30) for obtaining the sound information based on the information, added to the e-mail message, about the sound information, said sound information obtaining unit (30) then storing the thus obtained sound information, as the sound information related to the e-mail message, to said sound information storing unit (23);
a sound information reproducing unit (31) for reproducing the sound information stored in said sound information storing unit (23); and
a sound replay unit (42) for replaying the sound information, reproduced by said sound information reproducing unit (31), through said telephone number.

21. An e-mail system as set forth in claim 20, further comprising:
a caller number obtaining unit (25) for obtaining a telephone number of said second information terminal (40) from which a telephone call is made to the telephone number selected by said telephone number selecting unit (18);
a telephone number detecting unit (26) for detecting whether or not a combination of the telephone number that is selected by said telephone number selecting unit (18) and the telephone number that is obtained by said caller number obtaining unit (25) matches a pre-determined combination; and
a selecting unit (27) for selecting, if the detection result by said telephone number detecting unit (26) is positive, the sound information as that which is to be reproduced by said sound information reproducing unit (31).

22. An e-mail system as set forth in claim 20, wherein said managing apparatus (10e, 10f, 10g, 10h, 10j, 10m, 10n) prepares, based on the association managed by said managing unit (19), reproduction information, as a reproduction information notification e-mail message, that an e-mail message which is addressed to said second information terminal (40), and to which information about sound information is added, has been received from said first information terminal (70).

23. An e-mail system as set forth in claim 22, wherein said reproduction information notification e-mail message includes said telephone number selected by said telephone number selecting unit (18).

24. An e-mail system as set forth in claim 22, wherein said reproduction information notification e-mail message has a pointer for use in accessing information indicating said telephone number selected by said telephone number selecting unit (18).

25. An e-mail system as set forth in claim 21, wherein said managing apparatus (10e, 10f, 10g, 10h, 10j, 10m, 10nprepares, based on the association managed by said managing unit (19), reproduction information, in the form of web data placed on the Internet, that an e-mail message which is addressed to said second information terminal (40), and to which information about sound information is added, has been received from said first information terminal (70).

26. An e-mail system as set forth in claim 21, wherein, of said managing apparatus (10e, 10f, 10g, 10h, 10j, 10m, 10n),
said text information notifying unit (21) prepares a notification e-mail message that contains the text information to be notified to said second information terminal (40);
said telephone number selecting unit (18) selects a sound reproduction phone number for use in reproducing sound on said second information terminal (40); and
said telephone number notifying unit (21) adds information about the sound reproduction phone number, which is selected by said telephone number selecting unit (18), to the notification e-mail message, which is prepared by said text information notifying unit (21).

27. An e-mail system as set forth in claim 21, wherein, of said managing apparatus (10e, 10f, 10g, 10h, 10j, 10m, 10n),
said text information notifying unit (21) prepares notification web data to which said second information terminal (40) is accessible, said notification web data including at least the text information received from said first information terminal (70);
said telephone number selecting unit (18) selects a sound reproduction phone number for use in reproducing sound on said second information terminal (40); and
said telephone number notifying unit (21) adds information about the sound reproduction phone number, which is selected by said telephone number selecting unit (18), to the notification web data, which is prepared by said text information notifying unit (21).

28. An e-mail system as set forth in claim 27, further comprising an access detecting unit (28) for detecting whether or not access has been made by said second information terminal (40) to the notification web data,
if the detection result by said access detecting unit (28) is positive, said telephone number selecting unit (18) selecting said sound reproduction phone number, and
said sound information reproducing unit (31) reproducing the sound information to said second information terminal (40) which is connected to said sound reproduction phone number through sound communication.

29. An e-mail system as set forth in claim 26, wherein said information about the sound reproduction phone number is the sound reproduction phone number itself.

30. An e-mail system as set forth in claim 26, wherein said information about the sound reproduction phone number is an address of a web page indicating the sound reproduction phone number thereon or a pointer for use in accessing the web page.

31. An e-mail system as set forth in claim 14 wherein, if the e-mail message, transmitted from said first information terminal (70) to said second information terminal (40), has information added thereto about the sound information, said managing apparatus (10e, 10f, 10g, 10h, 10j, 10m, 10n) further comprises:
a sound information obtaining unit (30) for obtaining the sound information based on the information, added to the e-mail message, about the sound information, said sound information obtaining unit (30) then storing the thus obtained sound information, as the sound information related to the e-mail message, to said sound information storing unit (23);
a sound information reproducing unit (31) for reproducing the sound information stored in said sound information storing unit (23); and
a sound replay unit (42) for replaying the sound information, reproduced by said sound information reproducing unit (31), through an audio communication channel established by a telephone call made by said calling unit (29).

32. An e-mail system as set forth in claim 31, wherein said managing apparatus (10e, 10f, 10g, 10h, 10j, 10m, 10n) prepares, based on the association managed by said managing unit (19), reproduction information, as a reproduction information notification e-mail message, that an e-mail message which is addressed to said second information terminal (40), and to which information about sound information is added, has been received from said first information terminal (70).

33. An e-mail system as set forth in claim 32, wherein said reproduction information notification e-mail message has a pointer for use in accessing said notification web data.

34. An e-mail system as set forth in claim 31, wherein said managing apparatus (10e, 10f, 10g, 10h, 10j, 10m, 10n) prepares, based on the association managed by said managing unit (19), reproduction information, in the form of reproduction information notification web data placed on the Internet, that an e-mail message which is addressed to said second information terminal (40), and to which information about sound information is added, has been received from said first information terminal (70).

35. An e-mail system as set forth in claim 1, further comprising an identification information setting unit (32) for providing, if there are a plurality of such e-mail messages or if there are a plurality of such sound information items related to the individual e-mail messages, the individual e-mail messages or the individual sound information items with identification information for identifying the e-mail messages or the sound information items,
said managing unit (19) managing association among the e-mail messages and the sound information items related to the e-mail messages and the identification information provided by said identification information setting unit (32).

36. An e-mail system as set forth in claim 35, further comprising an identification information inputting unit (43) for inputting such identification information so as to specify the e-mail message or the e-mail-related sound information corresponding to the input identification information.

37. An e-mail system as set forth in claim 1, further comprising a sound guidance unit (24) for providing a user of said second information terminal (40) with guidance by voice.

38. An e-mail system as set forth in claim 1, further comprising a web guidance unit (13) for providing a user of said first information terminal (70) or a user of said second information terminal (40) with a web page that shows guidance thereon.

39. A method for transmitting electronic mail (e-mail) message that includes at least text information to be transmitted and received between a first information terminal (70) and a second information terminal (40), which first information terminal transmits and receives sound information and text information, and which second information terminal (40) transmits and receives sound information and text information in different ways,
said method comprising the steps of:
notifying said second information terminal (40) of the text information included in the e-mail message;
storing sound information related to the e-mail message; and
managing association between the e-mail message and the sound information related to the e-mail message.

40. An information processing apparatus, communicably interconnected between a first information terminal (70) for transmitting and receiving sound information and text information and a second information terminal (40) for transmitting and receiving sound information and text information in different ways, for managing an electronic mail (e-mail) message, including at least text information, transmitted and received between said first information terminal (70) and said second information terminal (40), said information processing apparatus comprising:
a text information notifying unit (21) for notifying said second information terminal (40) of the text information included in the e-mail message;
a sound information storing unit (23) adapted to store sound information related to the e-mail message; and
a managing unit (19) for managing association between the e-mail message and the sound information related to the e-mail message.

41. An electronic mail (e-mail) managing program which instructs a computer to function as an information processing apparatus, communicably interconnected between a first information terminal (70) for transmitting and receiving sound information and text information and a second information terminal (40) for transmitting and receiving sound information and text information in different ways, for managing an e-mail message, including at least text information, transmitted and received between said first information terminal (70) and said second information terminal (40), said information processing apparatus comprising:
a text information notifying unit (21) for notifying said second information terminal (40) of the text information included in the e-mail message;
a sound information storing unit (23) adapted to store sound information related to the e-mail message; and
a managing unit (19) for managing association between the e-mail message and the sound information related to the e-mail message.

42. A computer-readable recording medium storing an electronic mail (e-mail) managing program thereon, which program instructs a computer to function as an information processing apparatus, communicably interconnected between a first information terminal (70) for transmitting and receiving sound information and text information and a second information terminal (40) for transmitting and receiving sound information and text information in different ways, for managing an e-mail message, including at least text information, transmitted and received between said first information terminal (70) and said second information terminal (40), said information processing apparatus comprising:
a text information notifying unit (21) for notifying said second information terminal (40) of the text information included in the e-mail message;
a sound information storing unit (23) adapted to store sound information related to the e-mail message; and
a managing unit (19) for managing association between the e-mail message and the sound information related to the e-mail message.
